(19) United States
(12) Patent Application Publication
(10) Pub. No.: US 2023/0161232 A1
(43) Pub. Date: May 25, 2023

(54) HEATING APPARATUS FOR LENS, AND LENS ASSEMBLY AND METHOD FOR MANUFACTURING SAME

(71) Applicant: Ningbo Sunny Automotive Optech Co., Ltd, Ningbo City (CN)

(72) Inventors: Hujun HUANG, Ningbo City (CN); Leihong YE, Ningbo City (CN); Minbo HU, Ningbo City (CN); Hongyang ZHANG, Ningbo City (CN)

(73) Assignee: Ningbo Sunny Automotive Optech Co., Ltd, Ningbo City (CN)

(21) Appl. No.: 18/151,193

(22) Filed: Jan. 6, 2023

Related U.S. Application Data
(63) Continuation of application No. PCT/CN21/04935, filed on Jul. 7, 2021.

(30) Foreign Application Priority Data
Jul. 7, 2020 (CN) 202010646602.X
Dec. 10, 2020 (CN) 202011433498.2
Jun. 21, 2021 (CN) 202121374019.4

(51) Int. Cl. G03B 17/55; G03B 17/12; H05B 3/06; H01B 7/36; H05B 3/03; H05B 3/14

(52) U.S. Cl. CPC G03B 17/55; G03B 17/12; H05B 3/06; H01B 7/366; H05B 3/03; H05B 3/141

(57) ABSTRACT

A heating device for a lens, and an optical camera and a method for manufacturing same. A lens (1000) comprises a lens body, the lens body has a first surface (1100) and a second surface (1200) which are opposite to each other, and an edge (1300) that connects the first surface (1100) and the second surface (1200). The 5 heating device (1400) comprises: a heating unit adapted to be arranged on the edge (1300) of the lens body and used for transferring heat to the lens body after being powered. The heating device (1400) can achieve at least one of the beneficial effects such as a simple structure, high heat efficiency, uniform heating, safety in use, and strong weather resistance.

### CROSS-REFERENCE TO RELATED APPLICATIONS

This application is a continuation of international application No. PCT/CN2021/104935 filed on Jul. 7, 2021, which claims priorities to Chinese Patent Application No. 202010646602.X, filed in the National Intellectual Property Office of China (CNIPA) on Jul. 7, 2020, Chinese Patent Application No. 202011433498.2, filed in the National Intellectual Property Office of China (CNIPA) on Dec. 10, 2020, Chinese Patent Application No. 202121374019.4, filed in the National Intellectual Property Office of China (CNIPA) on Jun. 21, 2021. The aforementioned applications are hereby incorporated by reference in their entireties.

### TECHNICAL FIELD

The present disclosure relates to the technical field of optical devices, in particular, to a heating apparatus for a lens, a lens assembly having a heating apparatus, and a method for manufacturing a lens assembly having a heating apparatus.

### BACKGROUND

With the development of science and technology, optical apparatuses such as vehicle-mounted lens assemblies, optical lens assemblies, and optical lampshades are more and more applied in people's daily life. For example, in order to provide comfort and safety for car driving, vehicle-mounted lens assemblies are widely used in the fields such as front view, rear view, surround view, interior view, and side view of cars. At the same time, with the continuous development of automobile technology, the number and performance of vehicle-mounted lens assemblies required in cars have been greatly improved, and requirements for weather resistance of vehicle-mounted lens assemblies are also more stringent. When a vehicle is traveling in continuous rainy, frosty or alternatively cold and hot environments, inner and outer surfaces of a lens on a near-object side of the vehicle-mounted lens assembly are prone to fogging or frosting, which seriously affects an optical performance of the vehicle-mounted lens assembly and endangers people's driving safety.

In order to ensure the driving safety, the current commonly used means is to install a heat generating element in the vehicle-mounted lens assembly to heat and evaporate moisture attached to the surface of the lens or to prevent fogging or frosting. For example, an electric heating wire may be directly used to heat the lens assembly product to achieve functions of defogging and defrosting.

However, since the electric heating wire needs to be embedded in the lens to keep it fixed, it changes an original structure of the corresponding lens, which not only increases the difficulty of an overall manufacturing process of the lens assembly and increases costs, but also destroys strength of the corresponding lens, making the lens easy to crack especially after heating up, deteriorating an imaging quality, and the lens cannot be repaired. Moreover, the electric heating wire itself also has problems such as low heating efficiency, poor heating uniformity or complicated installation. In addition, if the heating material is directly embedded in the lens structure, it has problems such as weak overall stability of the lens assembly or poor weather resistance in bad weathers. Therefore, it is of great importance to develop a lens defogging product with simple structure, high heat efficiency, uniform heating, safety in use, and strong weather resistance.

### SUMMARY

The present disclosure provides a heating apparatus that may at least solve or partially solve at least one of the above disadvantages in the prior art.

According to an aspect of the present disclosure, a heating apparatus for a lens is provided. The lens comprises a lens body, the lens body having a first surface and a second surface opposite to each other, and an edge connecting the first surface and the second surface, the heating apparatus comprises: a heating unit, adapted to be arranged on the edge of the lens body and configured to transfer heat to the lens body after being powered.

According to another aspect of the present disclosure, The lens comprises a lens body, the lens body having a first surface and a second surface opposite to each other, and an edge connecting the first surface and the second surface, where the heating apparatus is arranged at the edge, and comprises a ceramic heating ring provided with a heat generating element or a polyimide heating film provided with the heat generating element.

According to an implementation of the present disclosure, the heating apparatus further comprises a fixing element, the fixing element being configured to fix the heating unit to the edge of the lens body. According to an implementation of the present disclosure, the fixing element is a thermal conductive glue or a thermal conductive tape.

According to an implementation of the present disclosure, the fixing element is a resilient member, and the ceramic heating ring or the polyimide heating film is fixed to the edge by resilience of the resilient element.

According to an implementation of the present disclosure, the fixing element is an electric conductive glue or an electric conductive tape.

According to an implementation of the present disclosure, the heat generating element is arranged between two layers of the polyimide film, and the heat generating element is connected to each polyimide film through at least one of the thermal conductive glue, the thermal conductive tape, the electric conductive glue or the electric conductive tape.

According to an implementation of the present disclosure, the polyimide heating film is a rigid carrier polyimide heating film.

According to an implementation of the present disclosure, the heat generating element is an electric heating wire.

According to an implementation of the present disclosure, the ceramic heating ring or the polyimide heating film has a ring-like structure.

According to an implementation of the present disclosure, the heating apparatus further comprises: an energy supply unit; and the electric conductive unit is configured to provide electrical connection between the heat generating element and the energy supply unit.

According to an implementation of the present disclosure, the electric conductive unit is connected to the heat generating element through one or more of welding, the electric conductive glue, the electric conductive tape, the thermal conductive glue, the thermal conductive tape, and compacting connection.

According to an implementation of the present disclosure, the heating apparatus further comprises a structural member, the structural member comprises: a structural member body, configured to fixedly connect to the lens; a first terminal, fixedly connected to the structural member body, configured to be rigidly fixedly connected and electrically connected to an external power supply; and a second terminal, electrically connected to the first terminal through the structural member body, and configured to electrically connect to the heating unit through the at least two leads.

According to an implementation of the present disclosure, the heating unit comprises a first film layer, a heat generating element, and a second film layer that are arranged in sequence.

According to another aspect of the present disclosure, a structural member is provided. The structural member is used to transmit the command generated by the first device to the second device set on the lens assembly body, the structural member comprises: a structural member body, configured to fixedly connect to the lens body; a first terminal, fixedly connected to the structural member body, configured to be rigidly fixedly connected to the first device and is communication connection with the first device; a second terminal, in communication connection with the first terminal through the structural member body, and in communication connection with the second device.

According to an implementation of the present disclosure, the structural member body comprises an electrical contact area, the first terminal is a first conductive end, electrically connected to the first electrical contact area and rigidly electrically connected to an output end of the first device; and the second terminal is a second conductive end, fixed in the first electrical contact area at a position corresponding to the second device.

According to an implementation of the present disclosure, the first conductive end is configured to position when the structural member is connected to the first device.

According to an implementation of the present disclosure, the first conductive end is arranged at a position of the structural member body, the position is corresponding to an output end of the first device.

According to an implementation of the present disclosure, a shape of the first electrical contact area is a dot shape, a closed loop shape, or a broken loop shape.

According to an implementation of the present disclosure, a the first conductive end and the second conductive end each comprises a positive electrode and a negative electrode, and the first electrical contact area comprises a first positive electrode area and a first negative electrode area; the positive electrode of the first conductive end is electrically connected to the first positive electrode area, and the positive electrode of the second conductive end is arranged at a position in the first positive electrode area corresponding to a positive power supply line of the second device; and the negative electrode of the first conductive end is electrically connected to the first negative electrode area, and the negative electrode of the second conductive end is arranged at a position in the first negative electrode area corresponding to a negative power supply line of the second device.

According to an implementation of the present disclosure, the structural member body has a mounting axis, and the structural member body is adapted to be fixedly connected to the lens by coinciding the mounting axis with an optical axis of the lens, the structural member body comprises at least one of: a first end surface and a second end surface opposite each other in a direction of the mounting axis, an inner peripheral surface surrounding the mounting axis, or an outer peripheral surface surrounding the mounting axis, wherein the second end surface faces towards the second device; the first positive electrode area is located on the second end surface, the inner peripheral surface, or the outer peripheral surface; the first negative electrode area is located on the second end surface, the inner peripheral surface, or the outer peripheral surface.

According to an implementation of the present disclosure, in a vertical plane of the mounting axis, a range of an inclined angle between the positive electrode and the negative electrode of the first conductive end in a circumferential direction of the mounting axis is from 0° to 360°.

According to an implementation of the present disclosure, in a vertical plane of the mounting axis, a range of an inclined angle between the positive electrode and the negative electrode of the second conductive end in a circumferential direction of the mounting axis is from 0° to 360°.

According to an implementation of the present disclosure, connection between the structural member body and the lens comprises at least one of: hole shaft interference fitting, hot riveting, broken ring snap fixing, snap hook fitting, screw locking fixing, hole shaft clearance fitting, or dispensing fixing.

According to an implementation of the present disclosure, a shape of the structural member body comprises at least one of: a circular ring shape, a rectangular ring shape, a trimmed shape, or a broken ring shape.

According to an implementation of the present disclosure, a shape of the first terminal comprises: a polygonal needle shape, a rectangular sheet shape, or a combination of the polygonal needle shape and the rectangular sheet shape.

According to an implementation of the present disclosure, the first terminal comprises a rigid pin header.

According to an implementation of the present disclosure, the second terminal is a second conductive end, connected to the second device through welding interconnection, or piercing connection.

According to an implementation of the present disclosure, the second conductive end has a recess for accommodating the second device, when the second conductive end is connected to the second device through piercing connection, the recess pierces an insulating sheath of the leads and makes electrical contact with the electric supply line.

According to another aspect of the present disclosure, a lens having a heating apparatus is provided. The lens includes the lens body, the lens body having a first surface and a second surface opposite to each other, and an edge connecting the first surface and the second surface, wherein the lens further comprises a heating apparatus, arranged on the edge of the lens body, configured to transfer heat to the lens body when powered, the heating apparatus is configured as a ceramic heating ring with a heat generating element provided inside or a polyimide heating film with the heat generating element provided inside.

According to an implementation of the present disclosure, the heating apparatus is arranged on at least one of an end surface or a side surface of the lens body on the edge.

According to an implementation of the present disclosure, the heating apparatus has a ring-like shape, the contour of the ring-like shape matches with the contour of the edge.

According to an implementation of the present disclosure, the lens is provided with a notch groove, and the heating apparatus is arranged in the notch groove.

According to an implementation of the present disclosure, the heating apparatus further comprises a fixing element, configured to fix the heating apparatus to the edge.

According to an implementation of the present disclosure, the fixing element is an resilient element, arranged in a compressed state on the edge.

According to an implementation of the present disclosure, the fixing element is an electric conductive glue or an electric conductive tape.

According to an implementation of the present disclosure, the fixing element is a thermal conductive glue or a thermal conductive tape.

According to an implementation of the present disclosure, a mechanism member is provided between lenses, and the ceramic heating ring is formed as the mechanism member.

According to an implementation of the present disclosure, the heat generating element is arranged between two layers of the polyimide film, and the heat generating element is connected to each of the polyimide film through at least one of thermal conductive glue, thermal conductive tape, electric conductive glue, or electric conductive tape.

According to an implementation of the present disclosure, the polyimide heating film is a rigid carrier polyimide heating film.

According to an implementation of the present disclosure, the heat generating element is an electric heating wire.

According to an implementation of the present disclosure, the heating apparatus further comprises: a conductive unit and an energy supply unit, the conductive unit comprises at least two leads, for electrically connecting the heat generating element and the energy supply unit.

According to an implementation of the present disclosure, the conductive unit is connected to the heat generating element through one or more of welding, electric conductive glue, electric conductive tape, thermal conductive glue, thermal conductive tape, and compacting connection.

In another aspect of the present disclosure, a lens assembly is provided. The lens assembly includes a lens barrel; a lens, the lens comprising a lens body, the lens body having a first surface and a second surface opposite to each other, and an edge connecting the first surface and the second surface, wherein the edge is connected to the lens barrel to fix the lens; and the heating apparatus described above.

In another aspect of the present disclosure, a lens assembly having a heating apparatus is provided, the lens includes a lens barrel, having a sidewall; and a plurality of lenses, fixed by the sidewall of the lens barrel, where at least one of the plurality of lenses is the lens having a heating apparatus.

According to an implementation of the present disclosure, the heating apparatus is arranged between the end surface of the lens body and a seal of the lens assembly.

According to an implementation of the present disclosure, the heating apparatus is arranged between an edge of the lens body and the sidewall of the lens assembly.

According to an implementation of the present disclosure, the heating apparatus is arranged between an edge of the lens body and an edge of an adjacent lens.

According to an implementation of the present disclosure, the heating apparatus is arranged between an edge of the lens body and a seal of the lens assembly and an edge of an adjacent lens.

In another aspect of the present disclosure, a lens assembly is provided. The lens assembly includes: a lens component; a lens barrel, connected to a non-optical area of the lens component to fix the lens component; a heating unit arranged in the non-optical area; and a connection component passes the lens barrel and is connected to the heating unit, where the connection member is suitable for connecting with an external power supply to supply power to the heating unit.

According to an implementation of the present disclosure, the heating unit comprises a first film layer, a heat generating element, and a second film layer that are arranged in sequence.

According to an implementation of the present disclosure, the first film layer and the second film layer are made of polyimide material; the heat generating element is made of at least one metal foil material in the rolled copper foil, electrolytic copper foil, Constantan copper foil, and stainless steel.

According to an implementation of the present disclosure, the heat generating element is arranged in a shape of wire on the edge, wherein a spacing and a width of the wire are greater than or equal to 0.02 mm.

According to an implementation of the present disclosure, a shape of the wire comprises at least one of circular shape, bow shape, zigzag shape, or circular ring shape.

According to an implementation of the present disclosure, the connection component includes a first connection component and a second connection component, where the first connection component and the second connection component are connected to positions on the heating unit close to the non-optical area.

According to an implementation of the present disclosure, the connection component includes a first connection component and a second connection component, where the first connection component and the second connection component are connected to positions on the heating unit away from the non-optical area.

According to an implementation of the present disclosure, the connection component includes a first connection component and a second connection component, where the first connection component and the second connection component are respectively connected to a position on the heating unit close to the non-optical area, a position on the heating unit away from the non-optical area.

According to an implementation of the present disclosure, the connection component includes a first connection component and a second connection component, where the first connection component and the second connection component are respectively connected to the inside of the heating unit.

According to an implementation of the present disclosure, the heating unit is stacked and arranged at the non-optical area, wherein the stacked connection component are electrically connected with each other.

According to an implementation of the present disclosure, the heating unit has at least one of: aperture marking, or notch marking.

According to an implementation of the present disclosure, a first reinforcing plate is set on a surface of the first film layer.

According to an implementation of the present disclosure, a second reinforcing plate is set on a surface of the second film layer.

According to an implementation of the present disclosure, the first reinforcing plate, the second reinforcing plate, or the first reinforcing plate and the second reinforcing plate, is formed of a thermally conductive material.

According to an implementation of the present disclosure, the thermally conductive material comprises: aluminum, stainless steel, or copper.

According to an implementation of the present disclosure, the first reinforcing plate, the second reinforcing plate, or the first reinforcing plate and the second reinforcing plate is formed of a thermal insulation material.

According to an implementation of the present disclosure, the thermal insulation material comprises: FR4, asbestos, vacuum plate, or aerogel felt.

According to an implementation of the present disclosure, the heating unit arranged folded is greater than or equal to 2 layers.

According to an implementation of the present disclosure, a contour shape of the heating unit comprises at least one of: circular ring shape, a square shape, a bow shape, and S shape.

In another aspect of the present disclosure, an optical apparatus is provided. The optical apparatus include the lens assembly described above.

In another aspect of the present disclosure, an optical apparatus is provided. The optical apparatus may be a lens assembly module. The lens assembly module include the lens assembly body, the lens assembly module further includes: a heater, configured to generate heat for heating the lens assembly body; a controller, configured to generate a control command for controlling operation of the heater to generate the heat; and a structural member, fixedly connected to the lens assembly body and rigidly fixedly connected to the controller, configured to transmit the control command generated by the controller to the heater.

According to an implementation of the present disclosure, the structural member comprises: a structural member body, fixedly connected to the lens assembly body; and a first conductive end, rigidly electrically connected to the controller to receive the control command from the controller; and a second conductive end, electrically connected to the heater and electrically connected to the first conductive end through the structural member body, configured to transmit the control command to the heater.

According to an implementation of the present disclosure, the first conductive end is arranged at a position of the structural member body corresponding to an output end of the controller. According to an implementation of the present disclosure, the structural member body comprises a first electrical contact area; the second conductive end is fixed at a position in the first electrical contact area corresponding to the heater;

and the first conductive end is electrically connected to the first electrical contact area.

According to an implementation of the present disclosure, the first conductive end is configured to position when the structural member is connected to the controller.

According to an implementation of the present disclosure, a shape of the first electrical contact area is dot shape, closed loop shape, or broken loop shape.

According to an implementation of the present disclosure, the first conductive end and the second conductive end each comprises a positive electrode and a negative electrode, and the first electrical contact area comprises a first positive electrode area and a first negative electrode area; the positive electrode of the first conductive end is electrically connected to the first positive electrode area, and the positive electrode of the second conductive end is arranged at a position in the first positive electrode area corresponding to a positive power supply line of a second device; and the negative electrode of the first conductive end is electrically connected to the first negative electrode area, and the negative electrode of the second conductive end is arranged at a position in the first negative electrode area corresponding to a negative power supply line of the second device.

According to an implementation of the present disclosure, the lens assembly body has an optical axis; and in a vertical plane of the optical axis, a range of an inclined angle between the positive electrode and the negative electrode of the first conductive end in a circumferential direction of the optical axis is from 0° to 360°.

According to an implementation of the present disclosure, the lens assembly body has an optical axis; and in a vertical plane of the optical axis, a range of an inclined angle between the positive electrode and the negative electrode of the second conductive end in a circumferential direction of the optical axis is from 0° to 360°.

According to an implementation of the present disclosure, the structural member body comprises at least one of a first end surface and a second end surface opposite each other in a direction of an optical axis of the lens assembly body, an inner peripheral surface surrounding the mounting axis, and an outer peripheral surface surrounding the mounting axis, wherein the second end surface faces towards the second device; the first positive electrode area is located on the second end surface, the inner peripheral surface, or the outer peripheral surface; the first negative electrode area is located on the second end surface, the inner peripheral surface, or the outer peripheral surface.

According to an implementation of the present disclosure, the lens assembly body comprises a lens barrel for accommodating at least one lens, wherein the structural member body is arranged on an outer sidewall of the lens barrel.

According to an implementation of the present disclosure, the lens assembly body comprises a lens barrel for accommodating at least one lens, an outer side surface of the lens barrel has at least one protruding portion, wherein the structural member body is arranged on the protruding portion.

According to an implementation of the present disclosure, the lens assembly body comprises a lens barrel for accommodating at least one lens, where the structural member body is arranged on an outer wall surface or a bottom surface of a bottom of the lens barrel.

According to an implementation of the present disclosure, the lens assembly body comprises a lens barrel for accommodating at least one lens, wherein the structural member body is arranged in a bore of a bottom of the lens barrel.

According to an implementation of the present disclosure, connection between the structural member body and the lens assembly body comprises at least one of: hole shaft interference fitting, hot riveting, broken ring snap fixing, snap hook fitting, screw locking fixing, hole shaft clearance fitting, or dispensing fixing.

According to an implementation of the present disclosure, the second conductive end is connected to the heater through welding interconnection, or piercing connection.

According to an implementation of the present disclosure, the second conductive end has a recess for accommodating a power supply line of the heater, when the second conductive end is connected to the heater through piercing connection, the recess pierces an insulating sheath of the power supply line and makes electrical contact with a wire of the power supply line.

According to an implementation of the present disclosure, the heater comprises a sensor and a heat generating element, and the sensor is configured to collect an ambient temperature of the lens assembly body; and the controller generates a command to control the heat generating element to generate the heat based on the ambient temperature detected by the sensor, or the controller generates a command to control the heat generating element to stop generating the heat based on the ambient temperature detected by the sensor.

In another aspect of the present disclosure, a method for manufacturing a lens assembly including a heating apparatus. The method comprises: manufacturing the heating apparatus described above; setting the heating apparatus on the lens to form the lens having the heating apparatus; setting a plurality of lenses comprised in the lens assembly on a lens barrel.

According to an implementation of the present disclosure, the lens comprises a lens body, the lens body has a first surface and a second surface opposite to each other, and an edge connecting the first surface and the second surface; the setting the heating apparatus on the lens to form the lens having the heating apparatus, comprises setting the heating apparatus on the edge of the lens body to form the lens having the heating apparatus.

According to an implementation of the present disclosure, the setting the heating apparatus on the edge of the lens body, comprises setting the heating apparatus on at least one of an end surface and a side surface of the lens body on the edge.

According to an implementation of the present disclosure, the setting the heating apparatus on the edge of the lens body, comprises setting the heating apparatus between an end surface of the lens body and a seal of the lens assembly.

According to an implementation of the present disclosure, a mechanism member is provided between lenses, and the ceramic heating ring is formed as the mechanism member. According to an implementation of the present disclosure, the setting the heating apparatus on the edge of the lens body, comprises: providing a notch groove on the edge; and setting the heating apparatus in the notch groove.

According to an implementation of the present disclosure, the setting the heating apparatus on the edge of the lens body, comprises setting the heating apparatus between the edge of the lens body and a sidewall of the lens assembly.

According to an implementation of the present disclosure, the setting the heating apparatus on the edge of the lens body, comprises: setting the heating apparatus between the edge of the lens body and an edge of an adjacent lens.

According to an implementation of the present disclosure, the setting the heating apparatus on the edge of the lens body, comprises: setting the heating apparatus between the edge of the lens body and a seal of the lens assembly and an edge of an adjacent lens.

In another aspect of the present disclosure, a method for manufacturing an optical apparatus is provided. The method includes: setting up a heater for generating heat to heat a lens assembly body; setting up a controller for generating a control command that controls the heater to generate the heat; setting up a structural member fixedly connected to the lens assembly body; and connecting the controller to the structural member rigidly fixedly, wherein the structural member is configured to transmit the control command generated by the controller to the heater.

According to an implementation of the present disclosure, the structural member comprises: a structural member body, a first conductive end, and a second conductive end, wherein the structural member body comprises a first electrical contact area and the second conductive end is electrically connected to the first electrical contact area; steps for setting up the structural member comprise: connecting the structural member body fixedly to the lens assembly body; connecting the second conductive end electrically to the heater; fixing the second conductive end at a position in the first electrical contact area corresponding to the heater, wherein the second conductive end is electrically connected to the first conductive end through the structural member body; and connecting the first conductive end rigidly electrically to an output end of the controller, to receive the control command from the controller.

According to an implementation of the present disclosure, the structural member comprises: a structural member body, a first conductive end, and a second conductive end; connecting the structural member body to the lens assembly body through at least one of: hole shaft interference fitting, hot riveting, broken ring snap fixing, snap hook fitting, screw locking fixing, hole shaft clearance fitting, or dispensing fixing.

According to an implementation of the present disclosure, the structural member comprises: a structural member body, a first conductive end, and a second conductive end; connecting the second conductive end to the heater through welding interconnection, or piercing connection.

According to the technical solutions of the above embodiments, at least one of the following beneficial effects may be obtained.

1. Easy to install: The ceramic heating ring heating apparatus may make corresponding dimensions according to use requirements of the lens assembly; in addition, in the polyimide PI heating film heating apparatus, the polyimide PI film is a translucent metal flexible electric heating film, which may change shape on some uneven lens surfaces to ensure good fit;

2. High heat utilization rate: The ceramic heating ring heating apparatus may customize an appearance according to the use requirements of the lens assembly to ensure that the heating apparatus can be in contact in a large area with a to-be-heated lens to improve a heating performance; in addition, the flexible polyimide PI heating film heating apparatus may change shape on the uneven lens surfaces to ensure that the heating apparatus can be in contact in a large area with a body of the to-be-heated lens, and a heat conduction efficiency of the polyimide PI film itself is high, which may greatly improve the heating performance of the heating apparatus;

3. Intelligent heating: Both the internal heat generating element of the ceramic heating ring heating apparatus and the internal heat generating element of the polyimide PI heating film heating apparatus have a large TCR (temperature coefficient of resistance), and its resistance increases with an ambient temperature. Under the same voltage input, the power of the heat generating element at low temperatures is high to achieve rapid heating; the resistance of the heat generating element at high temperature increases and the power decreases to ensure that an operating temperature of the heating apparatus may not be too high; at the same time, the TCR (temperature coefficient of resistance) may also be reduced close to zero by changing the material of the heat generating element to ensure that the heat generating element can output at a constant power;

4. Stable material: Since the ceramic heating ring heating apparatus itself uses ceramic materials, its properties are stable, the ceramic heating ring heating apparatus can withstand all kinds of external environments, and has high reliability.

5. Small size: The overall film thickness of the polyimide PI heating film heating apparatus may be reduced, the space occupied is small, and it has wide applicability.

6. The structural member is used to transmit the control command generated by the second device to the first device. The arrangement of the structural member provides convenience for the assembly of the first device and the second device, and also guarantees stability of the first device and the second device after the assembly.

7. A lens assembly module according to an embodiment of the present disclosure, the heater is connected to the controller by adding the structural member having a rigid conductive end, which reduces the difficulty of assembling the heater and the controller, and at the same time avoids uncontrollability of the power supply line of the heater, and guarantees stability of the heater and the controller after the assembly.

8. A lens assembly module according to an embodiment of the present disclosure, by adding the structural member that may adjust the position of the conductive end, the heater is connected to the controller. It avoids the situation in the prior art that assembly of the heater and the controller is impossible due to mismatch between the lead-out position of the power supply line of the heater and the position of the output end of the controller, thereby reducing the difficulty of assembling the heating lens assembly and the controller, and improving an assembly efficiency and production capacity of the heating lens assembly and the controller.

9. A method for manufacturing a lens assembly module according to an embodiment of the present disclosure, the first conductive end of the structural member is accurately positioned based on the position of the output end of the controller, and the second conductive end of the structural member is accurately positioned based on the position of the power supply line of the heater, then the heater is connected to the controller through the structural member, which avoids the situation in the prior art that assembly of the heater and the controller is impossible due to mismatch between the lead-out position of the power supply line of the heater and the position of the output end of the controller, thereby reducing the difficulty of assembling the heating lens assembly and the controller, and improving the assembly efficiency and production capacity of the heating lens assembly and the controller.

10. A method for manufacturing a lens assembly module according to an embodiment of the present disclosure, the heater is connected to the controller by adding the structural member having a rigid conductive end, which reduces the difficulty of assembling the heater and the controller, and at the same time avoids uncontrollability of the power supply line of the heater, and guarantees stability of the heater and the controller after the assembly. According to at least one solution in the lens having a heating apparatus provided above in the present disclosure, at least one of the following beneficial effects may be achieved:

11. A heating module is provided in the lens assembly, which may effectively remove fog and ice crystals generated on the lens assembly;

12. The heating module is provided inside the lens assembly, which may control an overall architecture of the lens assembly and reduce installation space of the lens assembly; and

13. The present disclosure may flexibly design a position and shape of the heating module to improve diversity and actual processing requirements of the heating module.

### BRIEF DESCRIPTION OF THE DRAWINGS

By reading detailed description of non-limiting embodiment made with reference to the accompanying drawings below, other features, objectives and advantages of the present disclosure will become more obvious:

FIGS. 1A to 1H are cross-sectional views of a lens having a heating apparatus according to an embodiment of the present disclosure;

FIGS. 2A to 2F are cross-sectional views of a notch groove of a lens having a heating apparatus according to an embodiment of the present disclosure;

FIG. 3 is a schematic diagram of a position of a fixing element in a lens assembly according to another embodiment of the present disclosure;

FIGS. 4A to 4I are cross-sectional views and partially enlarged views of a lens having a polyimide heating film heating apparatus according to another embodiment of the present disclosure;

FIG. 5A is a cross-sectional view of a lens having a polyimide heating film heating apparatus according to another embodiment of the present disclosure;

FIG. 5B is a partial cross-sectional enlarged view of a portion Y in FIG. 5A;

FIGS. 6A to 6C are cross-sectional views of a conductive unit in a lens having a ceramic heating ring heating apparatus according to an embodiment of the present disclosure;

FIG. 7A is a cross-sectional view of a conductive unit in a lens having a polyimide heating film heating apparatus according to another embodiment of the present disclosure;

FIG. 7B is a cross-sectional view of a conductive unit in a lens having a polyimide heating film heating apparatus according to another embodiment of the present disclosure;

FIG. 7C is a partial cross-sectional enlarged view of a portion Z in FIG. 7B;

FIG. 7D is a cross-sectional view of a conductive unit in a lens having a polyimide heating film heating apparatus according to another embodiment of the present disclosure;

FIG. 7E is a partial cross-sectional enlarged view of a portion A in FIG. 7D;

FIG. 7F is a partial cross-sectional enlarged view of a portion B in FIG. 7D;

FIG. 8A is a cross-sectional view of a conductive unit in a lens having a polyimide heating film heating apparatus according to another embodiment of the present disclosure;

FIG. 8B is a cross-sectional view of a conductive unit in a lens having a polyimide heating film heating apparatus according to another embodiment of the present disclosure;

FIG. 8C is a partial cross-sectional enlarged view of a portion C in FIG. 8B;

FIG. 8D is a cross-sectional view of a conductive unit in a lens having a polyimide heating film heating apparatus according to another embodiment of the present disclosure;

FIG. 8E is a partial cross-sectional enlarged view of a portion D in FIG. 8D;

FIG. 8F is a partial cross-sectional enlarged view of a portion E in FIG. 8D;

FIG. 8G is a cross-sectional view of a conductive unit in a lens having a polyimide heating film heating apparatus according to another embodiment of the present disclosure;

FIG. 8H is a partial cross-sectional enlarged view of a portion F in FIG. 8G;

FIG. 9 is a schematic structural diagram of a lens assembly module of an exemplary embodiment of the present disclosure;

FIG. 10 is an enlarged view of an area μl of FIG. 9;

FIG. 11 is a schematic structural diagram of a structural member in a lens assembly module of an exemplary embodiment of the present disclosure;

FIG. 12 is a schematic diagram of a shape of a first conductive end in a lens assembly module of an exemplary embodiment of the present disclosure;

FIG. 13 is a schematic diagram of a shape of a first conductive end in a lens assembly module of another exemplary embodiment of the present disclosure;

FIG. 14 is a structural diagram of a structural member body in a lens assembly module of an exemplary embodiment of the present disclosure;

FIG. 15 is a top view of FIG. 14;

FIG. 16 is a structural diagram of a structural member body in a lens assembly module of another exemplary embodiment of the present disclosure;

FIG. 17 is a top view of FIG. 16;

FIG. 18 is a structural diagram of a structural member body in a lens assembly module of an exemplary embodiment of the present disclosure;

FIG. 19 is a top view of FIG. 18;

FIG. 20 is a schematic diagram of the connection between a structural member and a power supply line in a lens assembly module of an exemplary embodiment of the present disclosure;

FIG. 21 is a partially enlarged view of FIG. 20;

FIGS. 22 to 25 are schematic diagrams of a structural member fixed to different positions of a lens assembly body in a lens assembly module of an exemplary embodiment of the present disclosure;

FIGS. 26 to 29 are schematic diagrams of a shape of a structural member body in a lens assembly module of an exemplary embodiment of the present disclosure;

FIG. 30 is a schematic diagram of a position of a second conductive end on a structural member body in a lens assembly module an exemplary embodiment of the present disclosure;

FIG. 31 is a schematic diagram of a position of a first conductive end on a structural member body in a lens assembly module an exemplary embodiment of the present disclosure;

FIG. 32 is a flowchart of a method for manufacturing a lens assembly module of an exemplary embodiment of the present disclosure;

FIG. 33 is a schematic diagram of a lens assembly according to an embodiment of the present disclosure;

FIGS. 34A to 34D are schematic diagrams of arrangement of a heating wire according to an embodiment of the present disclosure;

FIGS. 35A to 38B are schematic diagrams of position arrangements of a first connection component and a second connection component according to an embodiment of the present disclosure;

FIGS. 39A to 39C are schematic diagrams of folding of a heating module according to an embodiment of the present disclosure;

FIGS. 40A to 40C are schematic diagrams of stacking of a heating module according to an embodiment of the present disclosure;

FIG. 41A and FIG. 41B are schematic diagrams of a heating module according to another embodiment of the present disclosure;

FIGS. 42A to 42D are schematic diagrams of a shape of a heating module according to an embodiment of the present disclosure; and

FIGS. 43A to 43C are schematic diagrams of a positional relationship between a heating module and a reinforcing plate according to an embodiment of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens without departing from the teachings of the present disclosure.

In the accompanying drawings, the thicknesses, sizes and shapes of the components are slightly adjusted for the convenience of explanation. The accompanying drawings are merely illustrative and not strictly drawn to scale. For example, the terms “roughly”, “approximately” and similar terms used herein are used as terms to indicate approximation, not as terms to indicate degree, and are intended to illustrate the inherent deviations in measured or calculated values that will be recognized by those of ordinary skill in the art.

It should be further understood that the terms “comprise,” “comprising,” “having,” “include” and/or “including,” when used in the specification, are expressions of openness rather than closure, specify the presence of stated features, elements and/or components, but do not exclude the presence or addition of one or more other features, elements, components and/or combinations thereof. In addition, expressions such as “at least one of” when preceding a list of listed features, modify the entire list of features rather than an individual element in the list. Further, the use of “may,” when describing the implementations of the present disclosure, relates to “one or more implementations of the present disclosure”. Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (i.e., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. In addition, unless clearly defined or contradicts the context, the specific steps included in the method described in the present disclosure do not have to be limited to the order described, but may be performed in any order or in parallel. The present disclosure will be described below in detail with reference to the accompanying drawings and in combination with the embodiments.

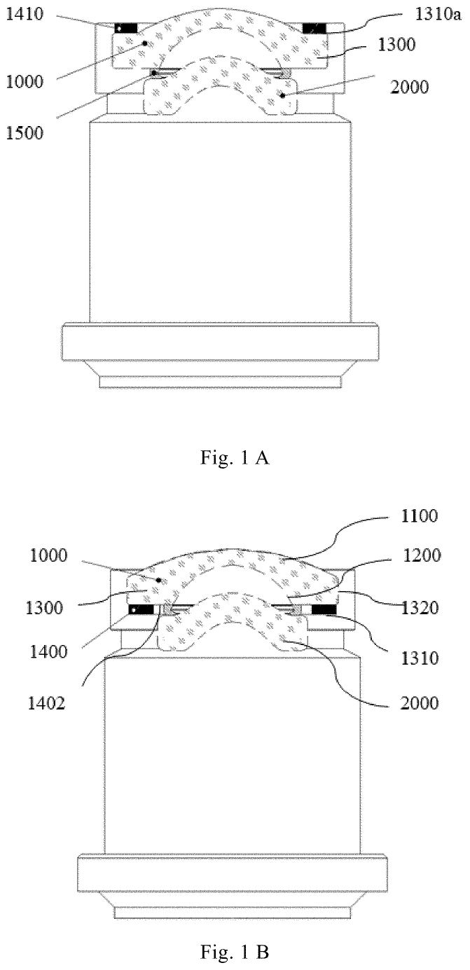

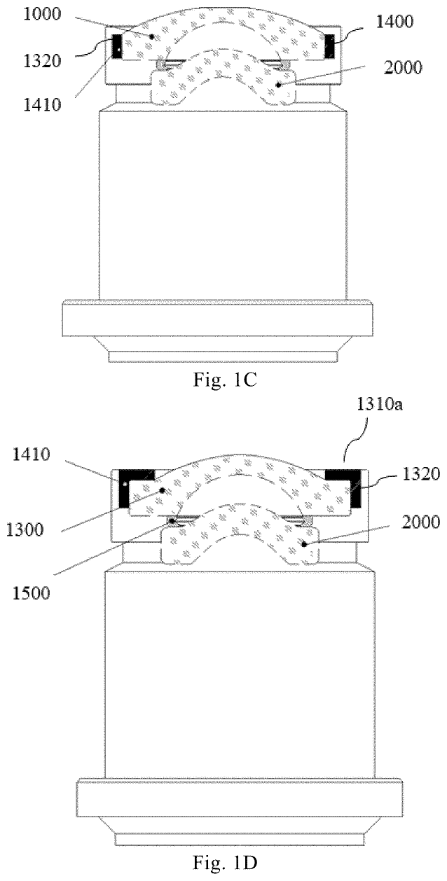

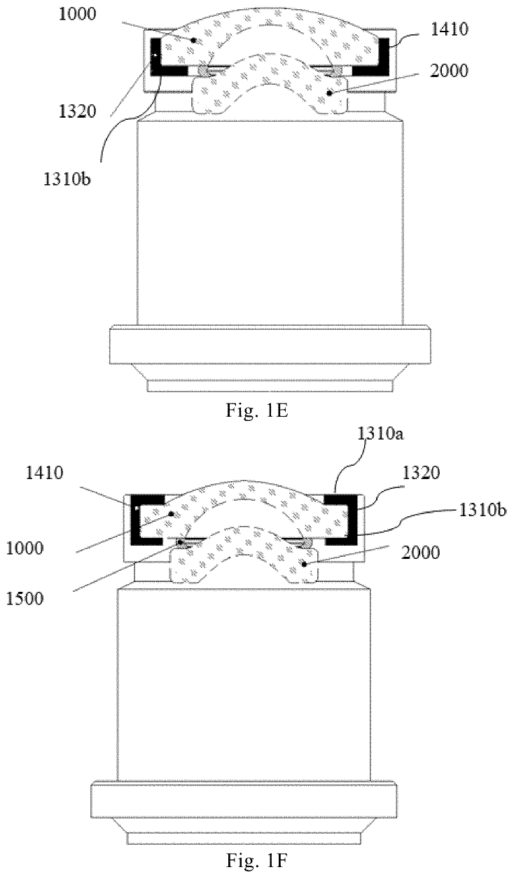

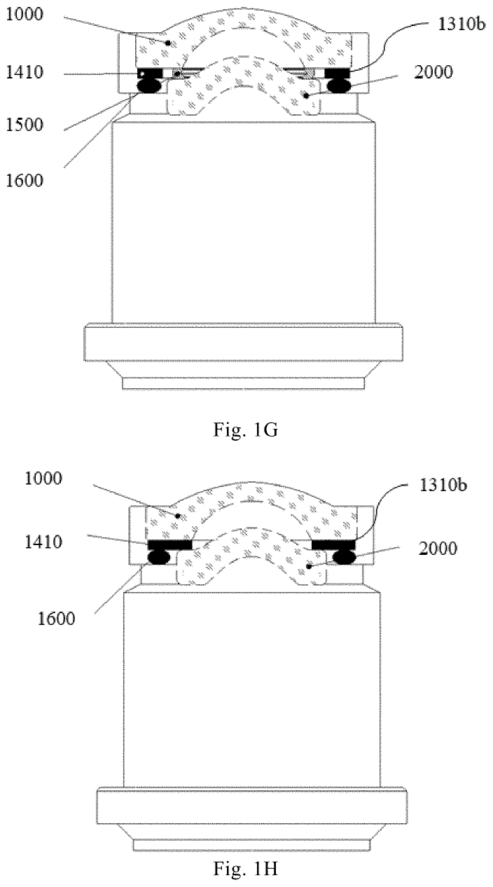

FIGS. 1A to 1C are cross-sectional views of a lens having a heating apparatus according to an embodiment of the present disclosure. As shown in FIGS. 1A to 1C, in an embodiment of the present disclosure, a first lens 1000 is arranged in an overall structure of a lens assembly, the overall structure of the lens assembly also includes a lens barrel and other lens(es), such as a second lens 2000. However, those of ordinary skill in the art should understand that without departing from the technical solution claimed in the present disclosure, the number of lenses having a heating apparatus or other related elements included in the lens assembly may be changed to obtain the various results and advantages described in this specification. The lens barrel may include a sidewall for fixing the lens. Each lens in the lens assembly is arranged along an axial direction of the lens assembly and mounted in the lens barrel in sequence. An edge of each lens is mounted on the sidewall of the lens barrel, where various modes, such as slotting on the sidewall to hold the edge of the lens, may be adopted to fix the lens in the lens barrel.

Considering that an outermost first lens in the lens assembly close to the object side is most susceptible to influence of temperature and climate in external environments such as rain and snow environment, low temperature environment, and/or high temperature environment, and condenses moisture on a surface of the lens. Therefore, alternatively, the first lens located on the object side in the lens assembly, such as the first lens 1000 in the present embodiment, is set as the lens having a heating apparatus, while other lens(es), such as the second lens 2000 in the present embodiment, may be set as an ordinary lens or a lens having a heating apparatus, since the second lens 2000 is less affected by the external environment, the second lens 2000 is not susceptible to condense moisture on the surface of the lens.

As shown in FIG. 1A, the first lens 1000 is composed of a lens body made of transparent material, the lens body has a first surface 1100 and a second surface 1200 opposite to each other, the first surface 1100 and the second surface 1200 are used to pass light for imaging. As shown in FIG. 1A, the first surface 1100 and the second surface 1200 may have a substantially arc-shaped contour, and a radius of the first surface 1100 is greater than a radius of the second surface and the first surface 1100 and the second surface are separated by a predetermined distance. In the present disclosure, a part connecting the first surface 1100 and the second surface 1200 is referred to as an edge 1300. The edge 1300 includes a surface 1310a extending along a cut from the first surface 1100 and being referred to as an “upper end surface” 1310a, a surface 1310b extending along a cut from the second surface 1200 and being referred to as a “lower end surface” 1310b (in the following description, “end surface 1310” is used to refer to the upper end surface 1310a and the lower end surface 1310b), and a surface 1320 referred to as a “side surface” 1320, the surface 1320 is substantially perpendicular to the upper end surface 1310a and the lower end surface 1310b and extends and connects to the second surface 1200.

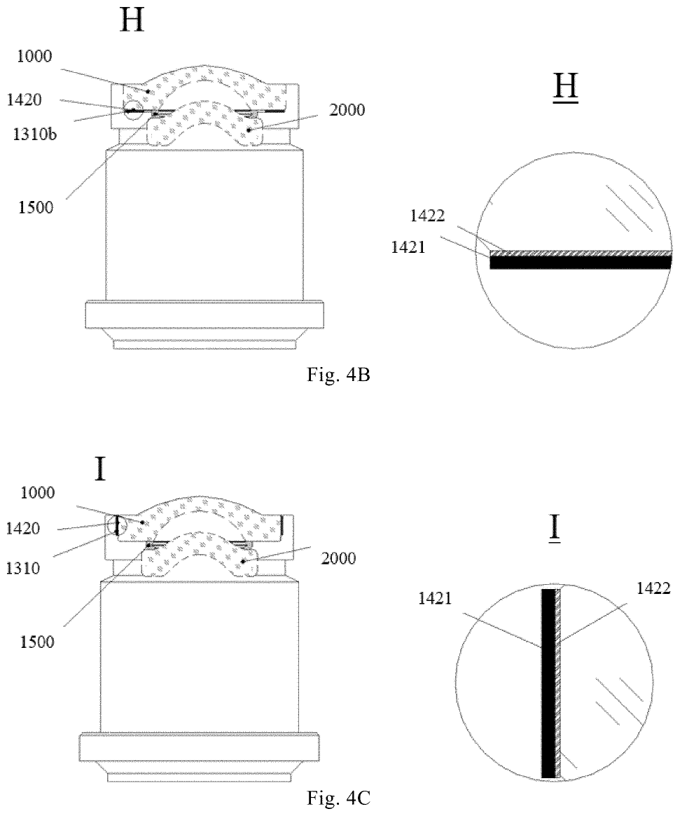

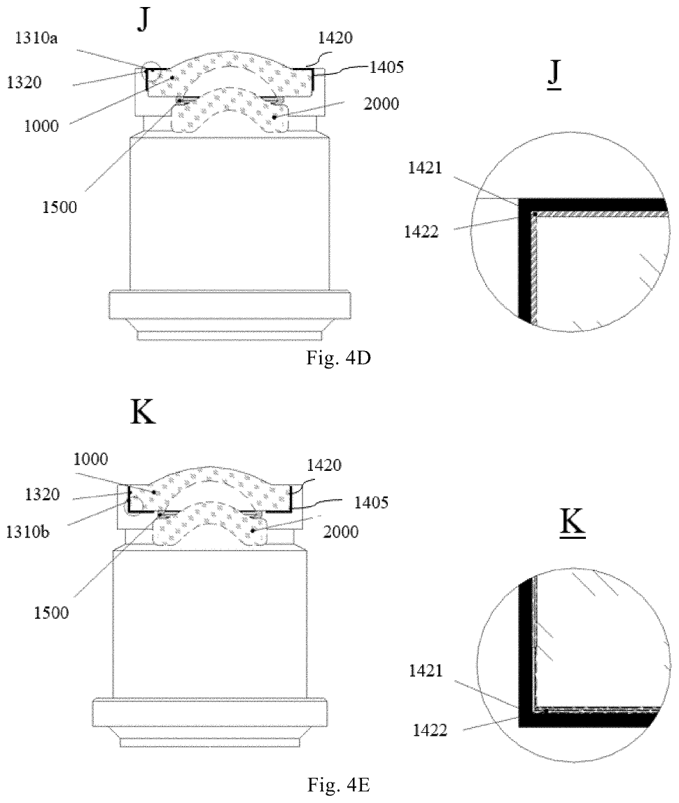

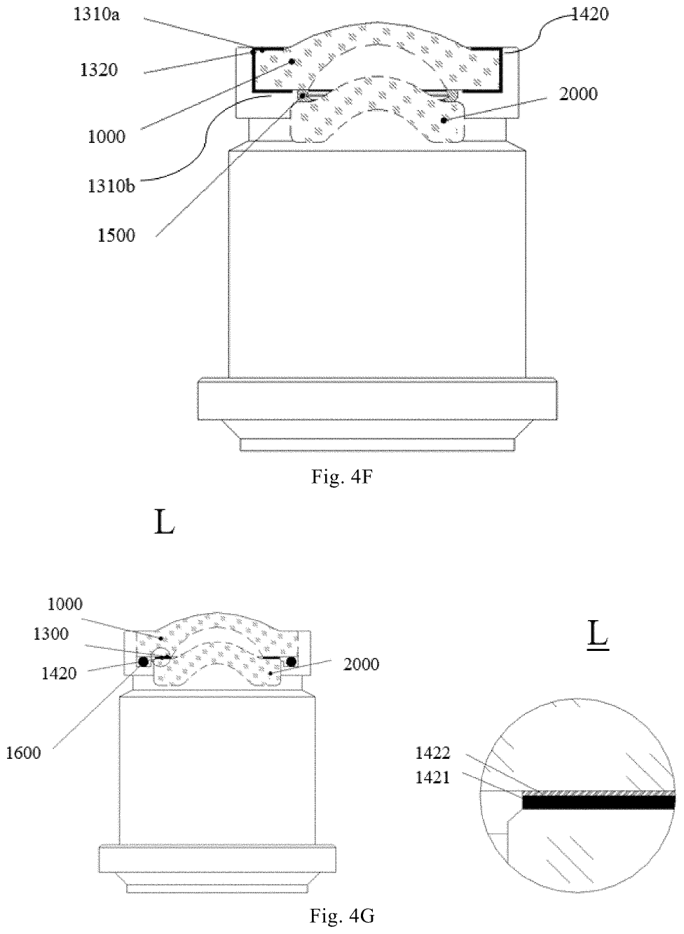

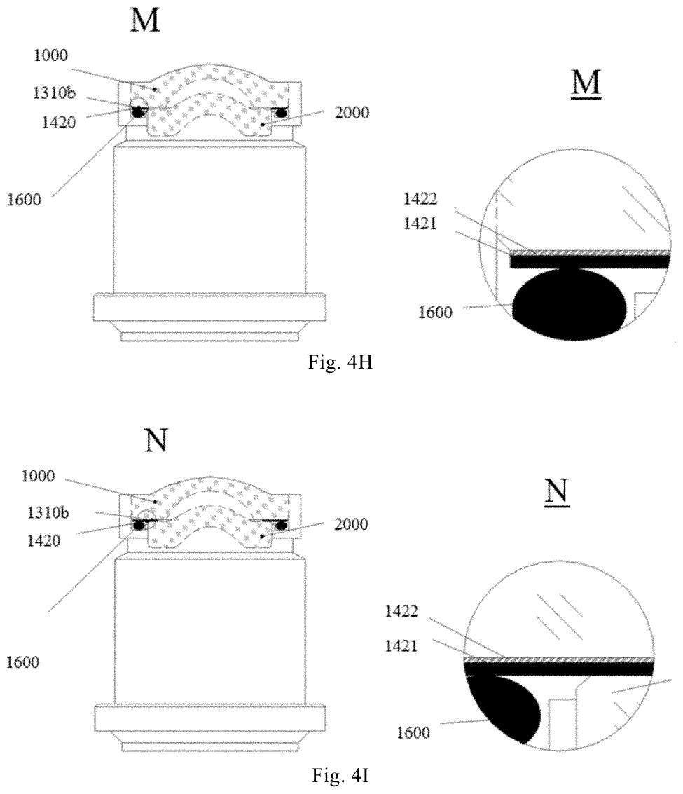

A heating apparatus 1400 may be arranged on the end surface 1310 at the edge 1300. The heating apparatus 1400 may be a ceramic heating ring heating apparatus 1410 (shown in FIG. 1A) or a polyimide PI heating film heating apparatus 1420 (as shown in FIG. 4A). However, those of ordinary skill in the art should understand that without departing from the technical solution claimed in the present disclosure, a type of the heating apparatus in the lens including a heating apparatus may be changed to obtain the various results and advantages described in this specification, for example, the heating apparatus 1400 may be one or more of the different apparatuses such as cast aluminum heater, electric heating belt, and/or mica heating sheet.

When the lens assembly is affected by the external environment, such as high temperature environment, low temperature environment, and/or rain and snow environment, moisture may condense on the surface of the lens. For a lens assembly installed with the first lens 1000 having the heating apparatus 1400, the heating apparatus 1400 may transfer heat to the first lens 1000 by means of heating conduction or thermal radiation, to evaporate or disperse moisture, effectively improving an overall weather resistance and reliability of the lens assembly.

In FIGS. 1A to 1H, a structure and operating process of the heating apparatus 1400 are described in detail using the ceramic heating ring heating apparatus 1410 as an example. The ceramic heating ring heating apparatus 1410 (hereinafter referred to as the heating apparatus 1410) may be arranged on the end surface 1310 at the edge 1300, that is, the heating apparatus 1410 may be arranged on the upper end surface 1310a (as shown in FIG. 1A) or the lower end surface 1310b (as shown in FIG. 1B) of the edge 1300.

As shown in FIG. 1C, the heating apparatus 1410 may also be arranged on the side surface 1320 of the first lens 1000 at the edge 1300; or the heating apparatus 1410 may also be provided simultaneously at the end surface 1310 (on the upper end surface 1310a or on the lower end surface 1310b) of the first lens 1000 at the edge 1300 and the side surface 1320. For example, the heating apparatus 1410 as shown in FIG. 1D is provided simultaneously at the upper end surface 1310a and the side surface 1320, the heating apparatus 1410 as shown in FIG. 1E is provided simultaneously at the lower end surface 1310b and the side surface 1320, or the heating apparatus 1410 as shown in FIG. 1F is provided simultaneously at the upper end surface 1310a, the lower end surface 1310b and the side surface 1320.

The heating apparatus 1400 may include a heat generating element. The heat generating element may be an electric heating wire. The temperature-inductive resistance of the electric heating wire has a large temperature coefficient of resistance (TCR). After power is supplied, a temperature-inductive resistance of the heat generating element increases with an ambient temperature. Under the same voltage input, when the ambient temperature is low, the power of the heating apparatus 1400 is high, which may achieve rapid heating; when the ambient temperature is high, the temperature-inductive resistance of the heat generating element increases, and the power of the heating apparatus 1400 decreases, so that the temperature of the heating apparatus 1400 may be guaranteed not to be over high. Therefore, after the power is supplied, the heating apparatus 1400 may heat the first lens 1000, so that the temperature of the first lens 1000 increases, thereby accelerating evaporation or accelerating dispersion of moisture (such as fog, frost, water droplets, or ice) attached to the first surface 1100 and the second surface 1200 of the first lens 1000. At the same time, the first lens 1000 may also be heated by the heating apparatus 1400 after the power supply, to prevent the first surface 1100 and the second surface 1200 of the first lens 1000 from condensing moisture, to prevent the lens assembly from being unclear or having blind spots, etc., to ensure imaging reliability of the first lens 1000.

Further, the heat generated by the heating apparatus 1400 may be transferred to the first lens 1000 by direct or indirect contact. First, the edge 1300 of the first lens 1000, which is tightly fixed to the heating apparatus 1400, receives the heat generated by the heating apparatus 1400 evenly by means of heat conduction, then the heat is evenly diffused from the edge 1300 to a center of the first lens 1000 by means of heat conduction and thermal radiation. In this way, the heat diffuses more evenly, which may effectively eliminate the moisture on the first surface 1100 and the second surface 1200 of the first lens 1000, and avoid local overheating of the first lens 1000.

The heating apparatus 1400 may be a ring-like structure, a contour of the ring-like structure matches a contour of the edge 1300 of the first lens 1000, so that the heating apparatus 1400 can be tightly fixed to the edge 1300 of the first lens 1000. However, those of ordinary skill in the art should understand that without departing from the technical solution claimed in the present disclosure, the shape and structure of the heating apparatus 1400 may be changed to obtain the various results and advantages described in this specification.

It is worth mentioning that a cross-sectional shape of the ring-like structure of the heating apparatus 1400 may be circular, rectangular, trapezoidal, stepped, etc., according to actual requirements. Without departing from the technical solution claimed in the present disclosure, the cross-sectional shape of the heating apparatus 1400 may be changed to obtain the various results and advantages described in this specification.

The heat generating element (not shown) in the heating apparatus 1400 is configured to generate heat required by the apparatus 1400 to provide to the first lens 1000 for fixing the heating apparatus 1400. The heat generating element may be a metal heating wire, such as nickel-iron wire, iron-chromium-aluminum wire, nickel-chromium wire. Alternatively, the heat generating element may contain one or more of the above electric heating wires. That is, the shape, structure or material of the heat generating element may be changed to obtain the various results and advantages described in this specification.

Further, a mechanism member 1500 may also be provided between the various lenses, for example, the mechanism member 1500 may ensure that in the lens assembly, for example, a safety gap with a constant distance between the first lens 1000 and the second lens 2000 maintains. In the present disclosure, the mechanism member 1500 may be directly set as the ceramic heating ring heating apparatus. As shown in FIG. 1G, the heating apparatus 1410 may also be arranged adjacent to the mechanism member 1500, i.e., arranged between the lower end surface 1310b of the first lens 1000 and a seal 1600 in an overall structure of the lens assembly; or as shown in FIG. 1C, the heating apparatus 1410 may be arranged between the first lens 1000 and a sidewall of the lens assembly; or as shown in FIG. 1H, the heating apparatus 1410 may directly replace the mechanism member 1500, acting as a spacer to separate adjacent lenses, arranged between the lower end surface 1310b of the first lens 1000 and a seal 1600 in an overall structure of the lens assembly.

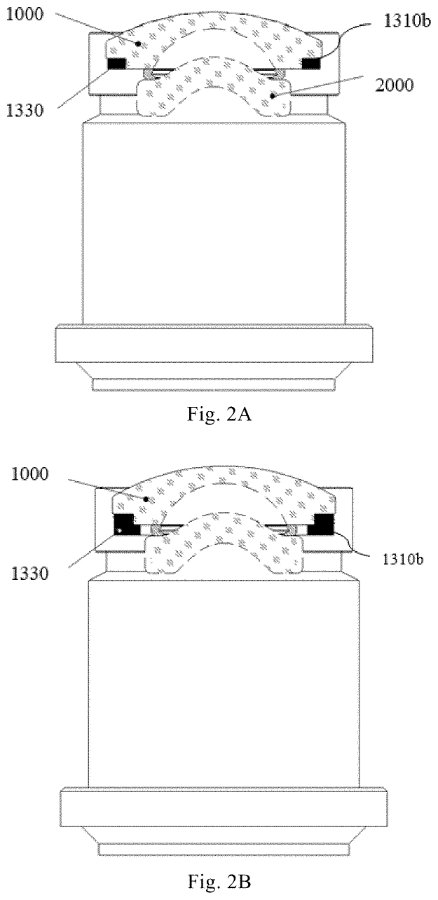

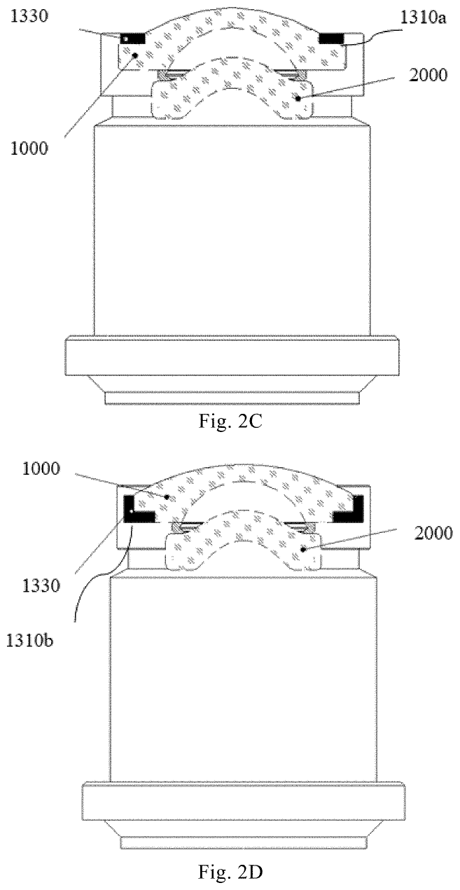

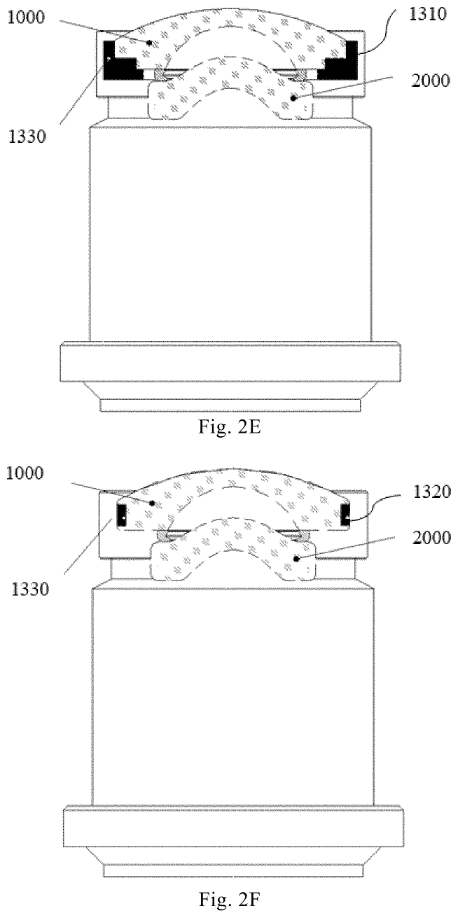

FIGS. 2A to 2F are cross-sectional views of a notch groove 1330 of the edge 1300 of the first lens 1000 having the heating apparatus 1400 according to an embodiment of the present disclosure. As shown in FIGS. 2A to 2F, in order to more conveniently and effectively install the heating apparatus 1400, the notch groove 1330 for accommodating the heating apparatus 1400 may be provided on the outside of the edge 1300 of the first lens 1000. The heating apparatus 1400 is arranged in the notch groove 1330 and is fixed to an inner wall of the notch groove 1330. The notch groove 1330 may be a rectangular notch groove, a triangular notch groove, or an arc-shaped notch groove, which is not limited herein, as long as a contact area between the heating apparatus 1400 and the first lens 1000 can be increased within a protection scope of the present disclosure.

In addition, as shown in FIGS. 2A to 2E, the notch groove 1330 may be arranged on the end surface 1310 of the edge 1300 of the first lens 1000. As shown in FIG. 2A, the notch groove 1330 is arranged on the lower end surface 1310b. As shown in FIG. 2B, the notch groove 1330 is arranged on the lower end surface 1310b, and is set to have a stepped rectangular groove. As shown in FIG. 2C, the notch groove 1330 is arranged on the upper end surface 1310a; As shown in FIGS. 2D and 2E, when heating apparatus 1400 is arranged in the notch groove 1330 at the end surface 1310, the heating apparatus 1400 may extend in a direction of the side surface 1320. As shown in FIG. 2F, the notch groove 1330 may be arranged on the side surface 1320 of the edge 1300 of the first lens 1000. As shown in FIGS. 2A to 2F, the notch groove 1330 being a rectangular notch groove is used as an example. However, those of ordinary skill in the art should understand that without departing from the technical solution claimed in the present disclosure, the shape and structure of the notch groove 1330 may be changed to obtain the various results and advantages described in this specification.

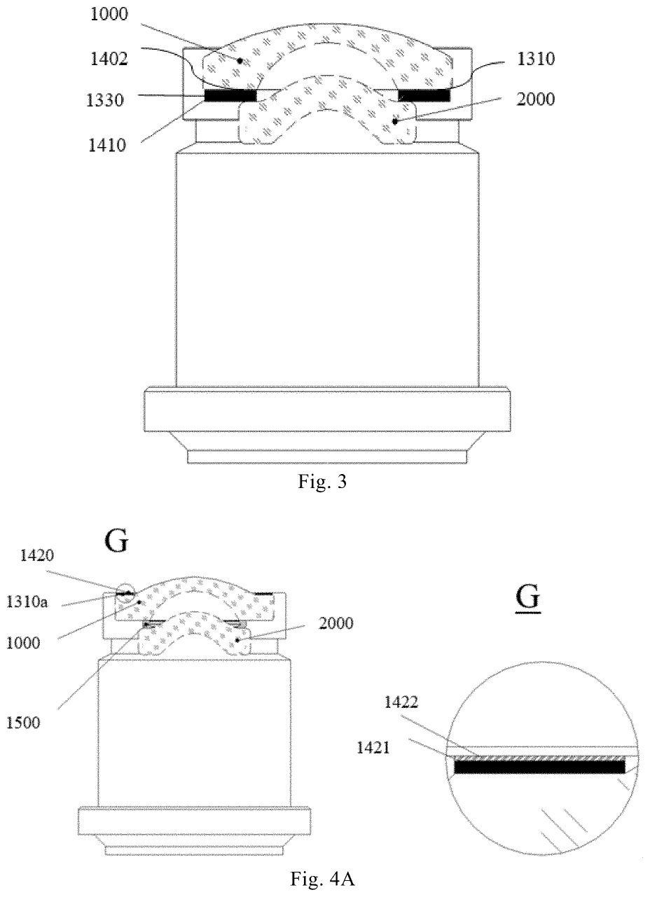

FIG. 3 is a schematic diagram of a position of a fixing element 1402 in a lens assembly according to an embodiment of the present disclosure. As shown in FIG. 3, in an embodiment of the present disclosure, the heating apparatus 1400 may also include the fixing element 1402. The fixing element 1402 may be any element capable of fixing the heating apparatus 1400 for fixing the heating apparatus 1400 to the first lens 1000 in the lens assembly. Through the fixing element 1402, the heating apparatus 1400 can be tightly fixed to the inner wall of the notch groove 1330, so as not to detach from the edge 1300 of the first lens 1000, and can always transfer heat to the edge 1300 by contact.

In an embodiment of the present disclosure, the fixing element 1402 may be a double-sided adhesive having good thermal conductivity, that is, the fixing element 1402 may be one or more of a thermal conductive glue or a thermal conductive tape. When the fixing element 1402 is the thermal conductive glue or the thermal conductive tape having good thermal conductivity, it is bonded between the heating apparatus 1400 and the edge 1300 of the first lens 1000, so that the heating apparatus 1400 can be tightly fixed to the edge 1300 of the first lens 1000. In another embodiment of the present disclosure, the fixing element 1402 may also be an resilient element, which may be placed at the edge 1300 in a compressed state. When the first lens 1000 is fixed to the sidewall of the lens assembly, the resilient element may rely on the resilience generated by a sidewall support force to tightly fix the heating apparatus 1400 to the edge 1300 of the first lens 1000, so that the heating apparatus 1400 can transfer heat to the edge 1300 of the first lens 1000 by heat conduction through the direct contact. However, those of ordinary skill in the art should understand that without departing from the technical solution claimed in the present disclosure, the position where the resilient element is arranged may be changed to obtain the various results and advantages described in this specification. For example, the resilient element may be arranged between the first lens 1000 and the second lens 2000.

In an embodiment of the present disclosure, the fixing element 1402 may also be a double-sided adhesive having good electric conductivity performance, that is, the fixing element 1402 may be one or more of an electric conductive glue or an electric conductive tape. When the fixing element 1402 is the electric conductive glue or the electric conductive tape, it is bonded between the heating apparatus 1400 and the edge 1300 of the lens 1000, so that the heating apparatus 1400 can be tightly fixed to the edge 1300 of the first lens 1000.

The fixing element 1402 itself may also be a locking element of the lens assembly, such as an external pressuring ring.

In the lens assembly system, the heating apparatus 1400 may be fixed between a lens and a lens barrel wall or between adjacent lenses through the fixing element 1402, such as between the first lens 1000 and the second lens 2000 or between a lens and a spacer ring.

In an embodiment of the present disclosure, the heating apparatus 1400 may be the ceramic heating ring heating apparatus 1410. The ceramic itself is material stable and may withstand various external environments. The ceramic heating ring heating apparatus 1410 made of ceramic material has high reliability as a whole. In addition, the ceramic itself has good thermal conductivity and insulation, which may provide perfect protection for the heat generating element, and because of its low production cost and easy-to-process appearance, external dimensions of the ceramic heating ring heating apparatus 1410 may be formulated according to the use requirements, and an external shape of the ceramic heating ring heating apparatus 1410 may be formulated based on an actual shape of the first lens 1000 to ensure that the ceramic heating ring heating apparatus 1410 can have a large contact area with the to-be-heated first lens 1000, effectively improving the utilization rate of heat energy.

In another embodiment of the present disclosure, the heating apparatus 1400 may be the polyimide PI heating film heating apparatus 1420. Polyimide film is a kind of translucent metal flexible electric heating film. Since it can change its shape on some uneven surfaces, the polyimide film can not only ensure a good fit with the end surface 1310 or the side surface 1320 of the first lens 1000, at the same time, can also ensure that its contact area with the to-be-heated first lens 1000 is large enough. Moreover, a heat conduction efficiency of the polyimide film itself is very high, therefore, while protecting the heat generating element, the polyimide film can greatly transfer heat generated by the heat generating element to the tightly fixed first lens 1000. In addition, a thickness of the polyimide film may be as low as, for example, 0.1 mm, which takes up very little space.

FIGS. 4A to 4I are cross-sectional views of the first lens 1000 having a polyimide heating film heating apparatus according to another embodiment of the present disclosure. In FIGS. 4A to 4I, there are partial schematic structural diagrams of lens portions G, H, I, J, K, L, M and N after ten times (10:1) enlargement. As shown in FIG. 4A, in an embodiment of the present disclosure, the internal structures of the polyimide (PI) heating film heating apparatus 1420 (hereinafter referred to as the heating apparatus 1420) may be distributed as a sandwich structure of PI film 1421+double-sided adhesive 1422+heat generating element+double-sided adhesive 1422+PI film 1421. That is, the heat generating element is arranged between the two layers of polyimide PI film 1421, and the heat generating element is bonded to each polyimide PI film 1421 by the double-sided adhesive 1422. The double-sided adhesive 1422 may be selected from one or more of the thermal conductive glue, the thermal conductive tape, the electric conductive glue, and/or the electric conductive tape.

Similarly, in the present embodiment, as shown in FIG. 4A, the heating apparatus 1420 may be arranged on the upper end surface 1310a of the edge 1300 of the first lens 1000; as shown in FIG. 4B, the heating apparatus 1420 may be arranged on the lower end surface 1310b; as shown in FIG. 4C, the heating apparatus 1420 may be arranged on the side surface 1320 at the edge 1300, and may be located between the edge 1300 and the side wall of the lens assembly; as shown in FIG. 4D, the heating apparatus 1420 may be simultaneously arranged on the upper end surface 1310a and the side surface 1320 at the edge 1300; as shown in FIG. 4E, the heating apparatus 1420 may be simultaneously arranged on the lower end surface 1310b and the side surface 1320 at the edge 1300; as shown in FIG. 4F, the heating apparatus 1420 may be simultaneously arranged on the upper end surface 1310a, the lower end surface 1310b, and the side surface 1320 at the edge 1300; as shown in FIG. 4G, the heating apparatus 1420 may be arranged between the edge 1300 of the first lens 1000 and the edge of the second lens 2000; as shown in FIG. 4H, the heating apparatus 1420 may be arranged between the lower end surface 1310b of the edge 1300 of the first lens 1000 and the seal 1600; and as shown in FIG. 4I, the heating apparatus 1420 may be arranged between the lower end surface 1310b of the edge 1300 of the first lens 1000 and an edge of the seal 1600 and the second lens 2000.

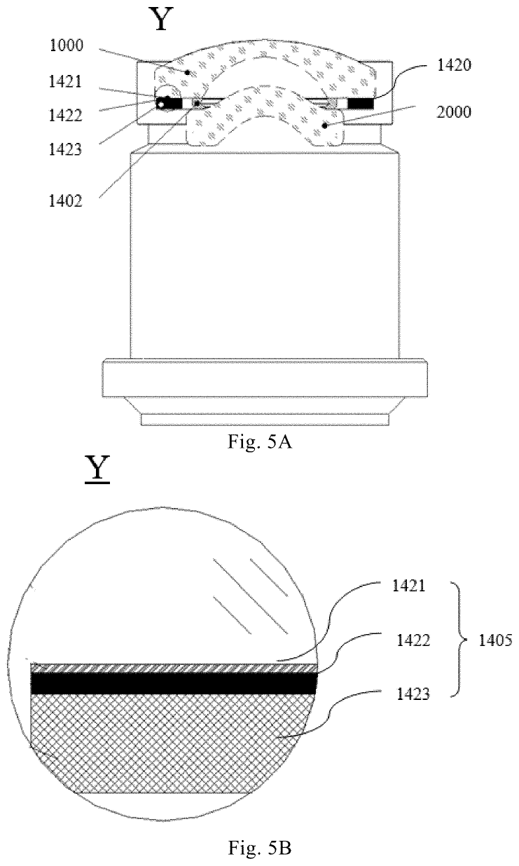

FIG. 5A is a cross-sectional view of a lens having a polyimide heating film heating apparatus according to another embodiment of the present disclosure. FIG. 5B is a partial schematic structural view after ten times (10:1) enlargement of a portion Y of the lens in FIG. 5A. As shown in FIG. 5B, in an embodiment of the present disclosure, the internal structures of the heating apparatus 1420 may be distributed as a sandwich structure of PI film 1421+double-sided adhesive 1422+heat generating element+double-sided adhesive 1422+PI film 1421+heat-resistant hard carrier 1423. That is, the PI film 1421 and the heat-resistant hard carrier 1423 may be combined into a hard carrier polyimide film, so that a protection unit 1405 including the hard carrier polyimide film has good rigidity, and accurate alignment can be ensured when the heating apparatus 1400 is installed on the first lens 1000, and automated production may be realized. In this multi-layer structure, the double-sided adhesive 1422 used may also be selected from one or more of the thermal conductive glue, the thermal conductive tape, the electric conductive glue and/or the electric conductive tape.

Similarly, in the present embodiment, as shown in FIG. 5A, the heating apparatus 1420 may be arranged on the end surface 1310 (the upper end surface 1310a or at the lower end surface 1310b) of the edge 1300 of the first lens 1000, arranged on the side surface 1320 of the edge 1300 of the first lens 1000 (as shown in FIG. 4C), arranged simultaneously on the end surface 1310 (at the upper end surface 1310a or at the lower end surface 1310b) and on the side surface 1320 of the first lens 1000 at the edge 1300 (as shown in FIGS. 4D, 4E and 4F), arranged between the edge 1300 of the first lens 1000 and the edge of the second lens 2000 (as shown in FIG. 4G), arranged between the lower end surface 1310b of the edge 1300 of the first lens 1000 and the seal 1600 (as shown in FIG. 4H), or arranged between the lower end surface 1310b of the edge 1300 of the first lens 1000 and the edge of the seal 1600 and the second lens 2000 (as shown in FIG. 4I).

Further, in another embodiment of the present disclosure, the heating apparatus 1400 may also include an energy supply unit (not shown). The energy supply unit may be a power equipment such as a battery or a power supply to provide electrical energy to the heat generating element.

Further, in another embodiment of the present disclosure, the heating apparatus 1400 may also include an electric conductive element 1403, depending on whether the protection unit 1405 is a ceramic ring or a polyimide PI film, a design structure of the electric conductive element 1403 may be slightly different.

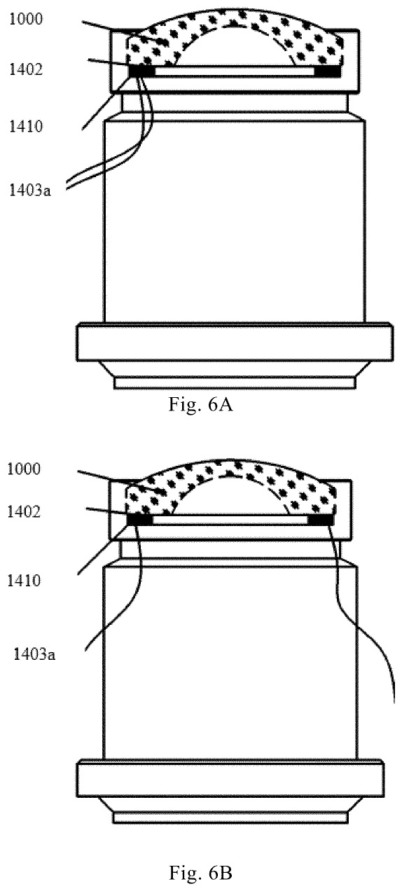

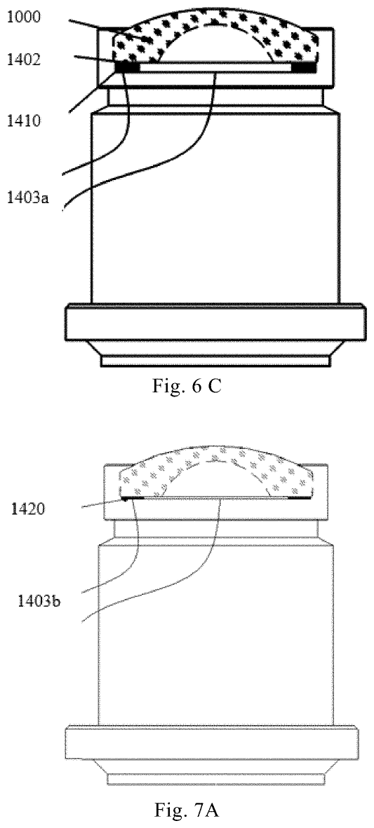

FIGS. 6A to 6C are cross-sectional views of the conductive unit 1403 in the first lens 1000 having the ceramic heating ring heating apparatus 1410 according to an embodiment of the present disclosure. As shown in FIGS. 6A to 6C, when the heating apparatus 1400 is the ceramic heating ring heating apparatus 1410, the conductive unit 1403 may have at least two leads 1403a, the at least two leads 1403a are for connecting the heat generating element and the energy supply unit. The two ends of the heat generating element are respectively connected to the conductive unit 1403, and the conductive unit 1403 is respectively connected to the positive and negative electrodes of the energy supply unit, so that the heat generating element is turned on, converts electrical energy into heat energy, and transfers the heat energy to the fixed first lens 1000.

In FIG. 6A, the at least two leads 1403a are designed to be installed on the same side of the heating apparatus 1410; in FIG. 6B, the at least two leads 1403a are designed to be installed on two sides of the heating apparatus 1410; in FIG. 6C, the at least two leads 1403a are designed to be installed on a specific position of the heating apparatus 1410, the specific position may be set based on special requirements of a structural design of the lens assembly including the first lens 1000, and may also be set based on a resistance of a temperature sensing resistor of the heat generating element actually used. The connection between the conductive unit 1403 and the heating apparatus 1410 may be selected from one or more of welding, electric conductive glue, electric conductive tape, thermal conductive glue, thermal conductive tape, and/or compacting connection.

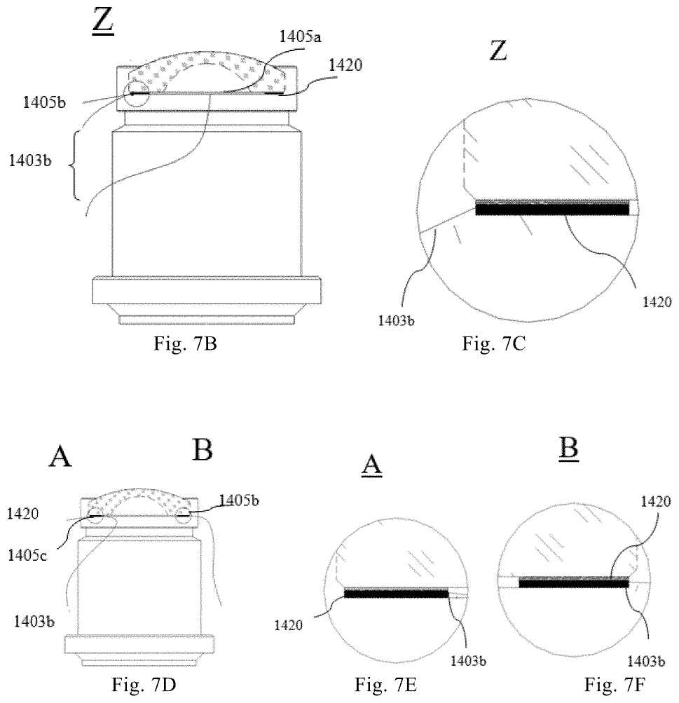

FIGS. 7A, 7B and 7D are respectively cross-sectional views of the conductive unit 1403 in the first lens 1000 having the polyimide heating film heating apparatus 1420 according to another embodiment of the present disclosure. As shown in FIGS. 7A, 7B and 7D, when the heating apparatus 1400 is the polyimide heating film heating apparatus 1420, the conductive unit 1403 may have at least two leads 1403b, the at least two leads are for connecting the heat generating element and the energy supply unit. Alternatively, when the heating apparatus 1400 is the polyimide heating film heating apparatus 1420, the heating apparatus 1420 may be directly extended and drawn out as a power supply wire. A heating wire inside the polyimide heating film, that is led out as the power supply wire, may be relatively wide to reduce the resistance, to ensure that the power supply wire may not take up a portion of the voltage (power supply voltage).

The two ends of the heat generating element are respectively connected to the conductive unit 1403, and the conductive unit 1403 is respectively connected to the positive and negative electrodes of the energy supply unit, so that the heat generating element is turned on, converts electrical energy into heat energy, and transfers the heat energy to the tightly fixed first lens 1000.

In FIG. 7A, the at least two leads 1403b are designed to be installed on an outer end surface of the polyimide film 1405 in the heating apparatus 1420; in FIG. 7C, a partial schematic structure of a portion Z of the lens enlarged ten times (10:1) is also shown; as shown in FIG. 7B, the at least two leads 1403b are designed to be installed on an outer end surface 1405a and an outer side surface 1405b of the polyimide film 1405 in the heating apparatus 1420; in FIGS. 7E and 7F, partial schematic structures of portions A and B of the lens enlarged ten times (10:1) are also shown; and as shown in FIG. 7D, the at least two leads 1403b are designed to be installed on the outer side surface 1405b and an inner side surface 1405c of the polyimide film 1405 in the heating apparatus 1420. In addition, the positions in the figures above are only examples. The actual positions of the at least two leads 1403b may be set based on the special requirements of the structural design of the lens assembly including the first lens 1000, and may also be set based on the resistance of the temperature sensing resistor of the heat generating element actually used, such as the end surface (both inside and outside) or the side surface (both inside and outside) of the polyimide film 1405 or a combination thereof. The connection between the conductive unit 1403 and the heating apparatus 1410 may be selected from one or more of welding, electric conductive glue, electric conductive tape, thermal conductive glue, t thermal conductive tape, and/or compacting connection.

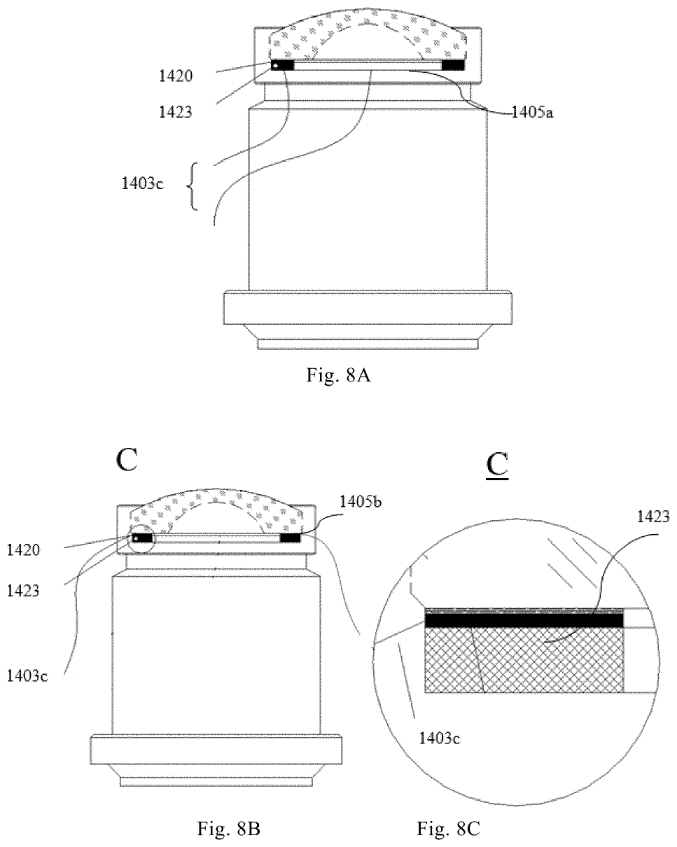

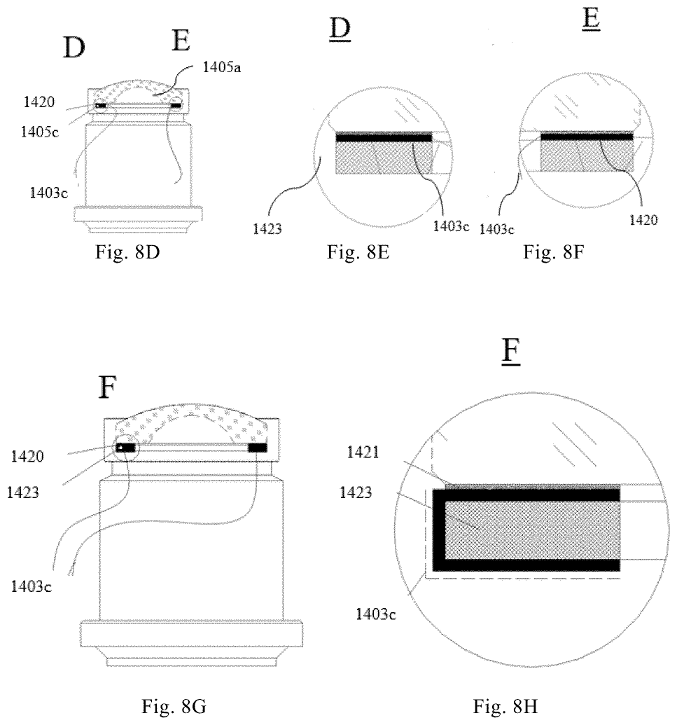

FIGS. 8A, 8B, 8D and 8G are respectively cross-sectional views of the conductive unit 1403 in the first lens 1000 having the polyimide heating film heating apparatus 1420 according to another embodiment of the present disclosure. As shown in FIGS. 8A, 8B, 8D and 8G, when the heating apparatus 1400 is the polyimide heating film heating apparatus 1420, the conductive unit 1403 may have at least two leads 1403c for connecting the heat generating element and the energy supply unit. The two ends of the heat generating element are respectively connected to the conductive unit 1403, and the conductive unit 1403 is respectively connected to the positive and negative electrodes of the energy supply unit, so that the heat generating element is turned on, converts electrical energy into heat energy, and transfers the heat energy to the fixed first lens 1000. In the present embodiment, a heat-resistant hard carrier is added to the polyimide PI heating film, so that the designed installation positions of the at least two leads 1403c are different from those of the at least two leads 1403a and the at least two leads 1403b.

In FIG. 8A, the at least two leads 1403c are designed to be installed on the outer end surface 1405a of the polyimide film 1405 in the heating apparatus 1420; in FIG. 8C, a partial schematic structure of a portion C of the lens enlarged ten times (10:1) is also shown; as shown in FIG. 8B, the at least two leads 1403c are designed to be installed on the outer side surface 1405b of the polyimide film 1405 in the heating apparatus 1420; in FIGS. 8E and 8F, partial schematic structures of portions D and E of the lens enlarged ten times (10:1) are also shown; as shown in FIG. 8D, the at least two leads 1403C are designed to be installed on the outer end surface 1405a and the inner side surface 1405c of the polyimide film 1405 in the heating apparatus 1420; in FIG. 8H, a partial schematic structure of a portion F of the lens enlarged ten times (10:1) is also shown. As shown in the figures, since the polyimide heating film is used as an extension line of the at least two leads 1403c, it extends to various positions of the heating apparatus 1420, and then electrically connected to the heat generating element and the energy supply unit. In addition, the positions in the figures above are only examples. The actual positions of the at least two leads 1403c may be set based on the special requirements of the structural design of the lens assembly including the first lens 1000, and may also be set based on the resistance of the temperature sensing resistor of the heat generating element actually used, such as the end surface (both inside and outside) or the side surface (both inside and outside) of the polyimide film 1405 or a combination thereof. The connection between the conductive unit 1403 and the heating apparatus 1410 may be selected from one or more of welding, electric conductive glue, electric conductive tape, thermal conductive glue, thermal conductive tape, and/or compacting connection. The above description is only an embodiment of the present disclosure and a description of the technical principles used. Those of ordinary skill in the art should understand that the protection scope involved in the present disclosure is not limited to the technical solution formed by specific combinations of the above technical features, and should also cover other technical solutions formed by any combination of the above technical features or their equivalent features without departing from the technical concept. For example, technical solutions formed by replacing the above features with technical features having similar functions disclosed in the present disclosure (but not limited to).

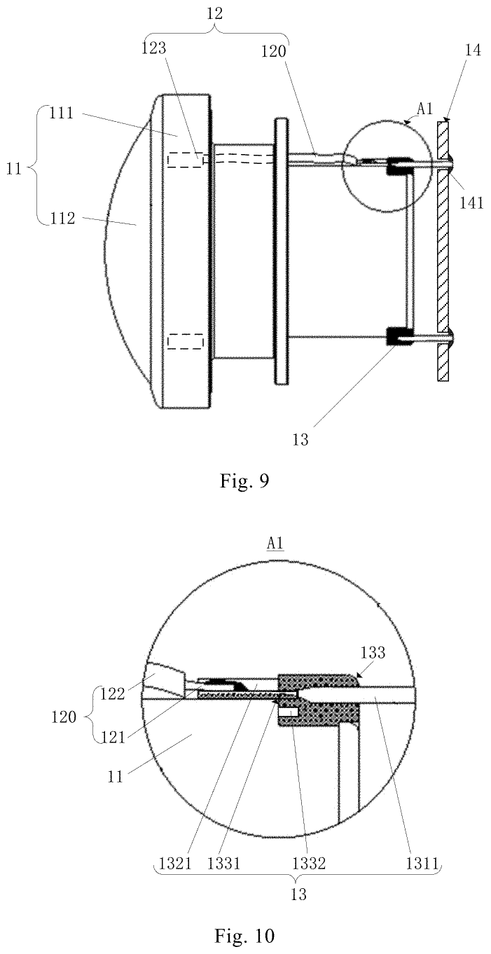

Referring to FIG. 9, which shows a schematic structural diagram of a lens assembly module of another embodiment of the present disclosure. As shown in FIG. 9, the lens assembly module according to an exemplary embodiment of the present disclosure may include a lens assembly body 11, a heater 12 and a structural member 13, and a controller 14. The lens assembly body 11 is equivalent to the overall structure of the lens assembly aforementioned. The heater 12 is configured to generate heat for heating the lens assembly body 11. The controller 14 is configured to generate a control command for controlling operation of the heater 12 to generate the heat. The structural member 13 is fixedly connected to the lens assembly body 11, and is configured to transmit the control command generated by the controller 14 to the heater 12. The structural member 13 and the lens assembly body 11 may be rigidly connected.

In some embodiments, the lens assembly body 11 is composed of at least one lens 112 and a lens barrel 111 capable of accommodating at least one lens, and is usually fixed to a vehicle body to assist a driver to obtain a clear field of vision, and at the same time may provide reliable evidence for judgement in traffic accidents. Therefore, the imaging quality of the lens assembly body 11 is essential. In order to enable the lens assembly body 11 to automatically defog and deicing in a cold and humid environment to ensure the imaging quality, the present embodiment has the heater 12 fixed and installed on the lens assembly body 11.

In some embodiments, the lens barrel 111 of the lens assembly body 11 is provided with a protruding portion, the protruding portion is an annular platform arranged in a circular direction around the lens barrel 111, and a diameter of the protruding portion is slightly larger than a diameter of the lens barrel 111. The protruding portion may be a flange, which may be used to position or fix when the lens assembly body 11 is connected to the controller 14.

In some embodiments, the heater 12 may be arranged in the lens barrel and acts directly on the lens. The heater 12 may include a heating unit 123 and a conductive unit. Illustratively, the heating unit 123 is arranged on an edge or non-optical area of the lens 122; and the conductive unit includes at least two power supply lines 120. The heating unit 123 may be composed of a temperature sensor (not shown) and a heat generating element (not shown). The temperature sensor detects a temperature of the environment in which the lens assembly body 11 is located in real time, and transmits the detected temperature value to the controller 14 in the form of an electrical signal. The controller 14 compares the received temperature value with a predetermined threshold. When the ambient temperature is lower than a first preset threshold, the controller 14 sends a heating command to the heater 12 in the form of an electrical signal. In response to receiving the heating command sent by the controller 14, the heat generating element in the heater 12 begins heating works to generate heat.

Further, when the temperature sensor senses in real time that the ambient temperature of the lens assembly body 11 exceeds a second preset threshold, that is, when it is proved that the lens 112 may not fog or freeze at the current ambient temperature, the controller 14 sends a command to the heater 12 to stop heating. When the heater 12 receives the command from the controller 14 to stop heating, the heat generating element stops heating.

The heater 12 and the controller 14 need to be electrically connected to achieve interaction of the above electrical signals, then it is necessary to connect the power supply line 120 of the heater 12 to an output end 141 of the controller 14. However, the position of the power supply line 120 of the heater 12 is constrained by the structure and positional relationship between the heater 12 and the lens assembly body 11, and thus cannot be adjusted based on the position of the output end 141 of the controller 14, and the position of the output end 141 of the controller 14 is not fixed. In order to avoid installation difficulties caused by mismatch between a lead-out position of the power supply line 120 of the heater 12 and the position of the output end 141 of the controller 14, the present embodiment provides the structural member 13 for connecting the heater 12 and the controller 14.

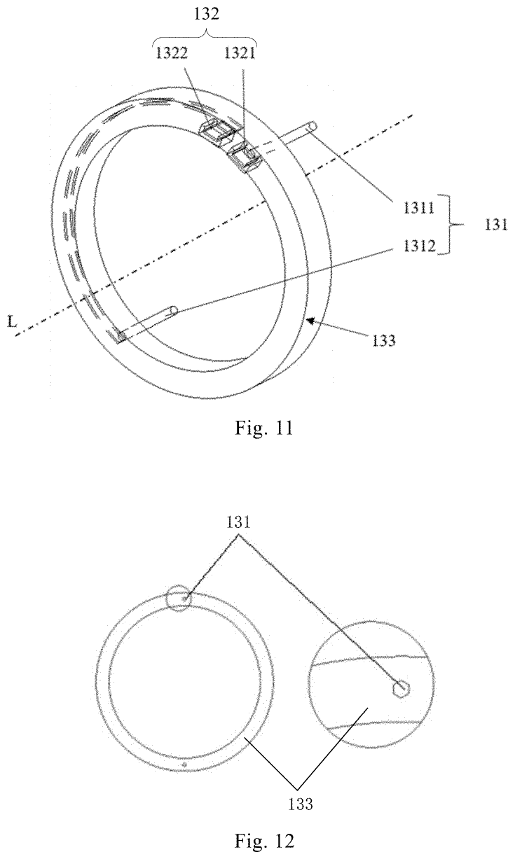

FIG. 10 is an enlarged view of an area μl of FIG. 9; and FIG. 11 is a schematic structural diagram of a structural member in a lens assembly module of an exemplary embodiment of the present disclosure. As shown in FIGS. 10 and 11, the structural member 13 includes a first conductive end 131, a second conductive end 132 and a structural member body 133. The first conductive end 131 may, for example, be arranged on a side of the structural member body 133, and has a positive electrode 1311 or a negative electrode 1312 electrically connected to the controller 14; the second conductive end 132 may be arranged on another side of the structural member body 133, and has a positive electrode 1321 or a negative electrode 1322 electrically connected to the heater 12. Illustratively, the positive electrode 1311 or the negative electrode 1312 of the first conductive end 131 is a rigid rod, such as a copper rod.

In order to enable the controller 14 to connect to the heater 12, the first conductive end 131 is arranged at a position that matches the position of the output end 141 of the controller 14. Illustratively, the controller 14 includes a printed circuit board (PCB). Since the position of the output end 141 of the controller 14 is randomly set based on a specific model, it is necessary to first accurately determine the position of the output end 141 of the controller 14, and find the position matching the position of the output end 141 of the controller 14 on the structural member body 133, then fixedly connect the first conductive end 131 to the structural member body 133 by means such as welding.

The first conductive end 131 may be configured to position when the structural member 13 is connected to the controller 14, which makes assembly of the lens assembly module more accurate and convenient.

In some embodiments, the connection between the first conductive end 131 and the output end 141 of the controller 14 may include: welding connection, or piercing connection. As shown in FIG. 9, the first conductive end 131 and the output end 141 of the controller 14 are welded and connected, the first conductive end 131 runs through the output end 141 of the controller 14, and is welded and fixed to ensure stability of its connection.

Referring to FIGS. 9 and 11, the controller 14 may be regarded as a first device, and the heater 12 arranged on the lens assembly body 11 may be regarded as a second device. The first device and the lens assembly body 11 need to be installed together. Due to different types and models of the first device, the position of the output end 141 on the first device is different. With assistance of the structural member 13 provided in the present disclosure, the first device and the second device may be accurately positioned during installation.

A first terminal (the first conductive end 131), the structural member body 133, and a second terminal (the second conductive end 132) are fixedly connected. The fixed connection may be rigid. The position of the first terminal is set in response to fixed positions of the structural member body 133 and the first device, the position of the second terminal is set in response to fixed positions of the structural member body 133 and the second device, and the first terminal and the second terminal are connected communicatively through the structural member body 133. Further, the controller 14 may be used as an external power supply for the heater 12, thereby supplying power to the heater 12.

The structural member 13 is configured to transmit commands output from the first device to the second device. The first device may transmit signals, such as electrical signals or optical signals, to the second device. The structural member 13 is also conducive to enhancing firmness of the first device and the second device after the installation. The first terminal is rigid and its material may be a conductive material. The first terminal may also be an electric conductive channel formed by setting a conductive material in a substrate of a dielectric material, or may be an optical channel formed by setting a refractive material in the substrate of the dielectric material. Further, the first terminal and the first device are electrically connected or communicated in other ways. At the same time, the second terminal is communicatively connected with the second device.

Illustratively, the structural member body 13 has a mounting axis L. The structural member body 13 may have multiple mounting positions after rotating along the mounting axis L, and may be used to connect to the lens assembly body 11. The structural member body 13 may also have only one mounting position. When the structural member body 13 is fixedly connected to the lens assembly body 11, the mounting axis L may coincide with an optical axis of the lens assembly body 11.

Illustratively, the first terminal is a rigid pin header. The rigid pin header may be solid or hollow. The rigid pin header has a good degree of position when installed to the first device. When the rigid pin header is used for conducting electricity, an output end of the first device may be a pad hole. The rigid pin header is rigidly connected and may be electrically connected to the pad hole. Further, the rigid pin header may be welded to the pad hole.

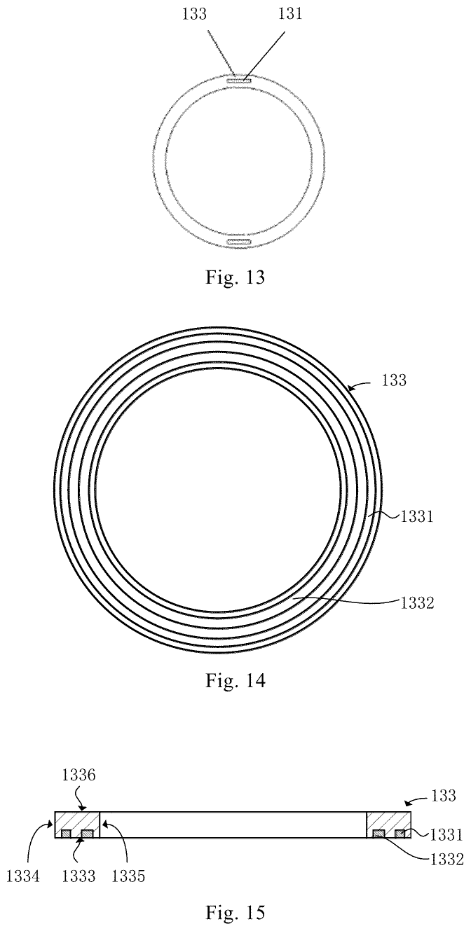

FIG. 12 is a schematic diagram of a shape of a first conductive end in a lens assembly module of an exemplary embodiment of the present disclosure; and FIG. 13 is a schematic diagram of a shape of a first conductive end in a lens assembly module of another exemplary embodiment of the present disclosure.

In some embodiments, in order to make the first conductive end 131 and the output end 141 of the controller 14 more easily fixedly connected, as shown in FIG. 12, the first conductive end 131 may be set to a polygonal needle shape. Or as shown in FIG. 13, the first conductive end 131 may be set as a rectangular sheet shape. Alternatively, the shape of the first conductive end 131 may be a combination of the rectangular sheet shape and the polygonal needle shape. Of course, an extension length of the first conductive end 131 is short. The polygonal needle shape may be circular needle shape, rectangular needle shape, hexagonal needle shape, etc. In addition, the first conductive end 131 must be made of metal. Compared with the power supply line 120, this short needle shape or sheet shape metal connection end has strong rigidity and is easy to be connected and fixed to the output end 141 of the controller 14.

In some embodiments, the second conductive end 132 is arranged on a side of the structural member body 133, and is located on a different side from the first conductive end 131. A shape of a first electrical contact area of the second conductive end 132 and the structural member body may be at least one of: dot shape, closed loop shape, and/or broken loop shape. Since the electrodes of the second conductive end 132 include the positive electrode 1321 and the negative electrode 1322, the first electrical contact area of the structural member body and the second conductive end 132 is also divided into a first positive electrode area 1331 and a first negative electrode area 1332.

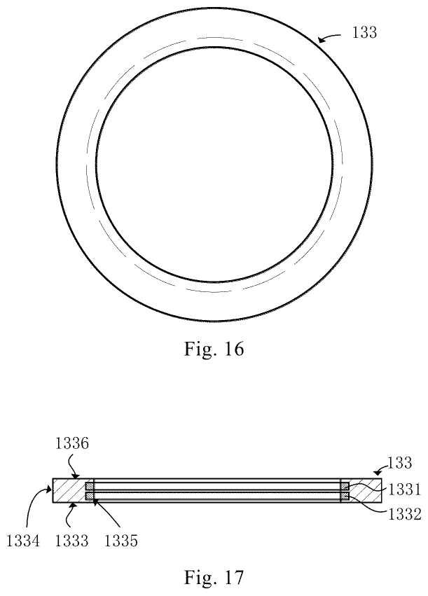

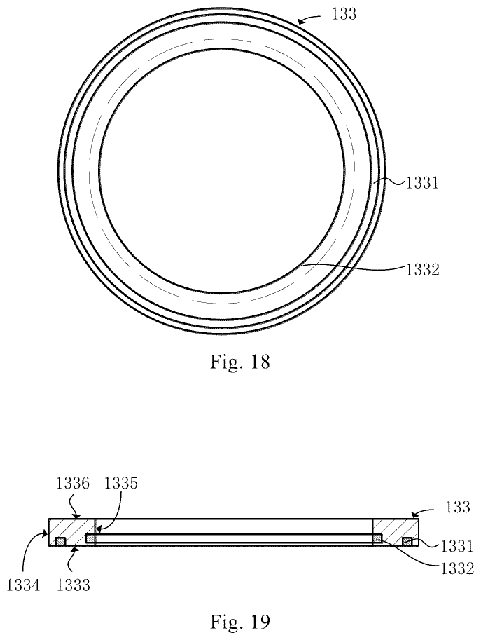

FIG. 14 is a structural diagram of a structural member body in a lens assembly module of an exemplary embodiment of the present disclosure; FIG. 15 is a top view of FIG. 14; FIG. 16 is a structural diagram of a structural member body in a lens assembly module of another exemplary embodiment of the present disclosure; FIG. 17 is a top view of FIG. 16; FIG. 18 is a structural diagram of a structural member body in a lens assembly module of an exemplary embodiment of the present disclosure; and FIG. 19 is a top view of FIG. 18.

As shown in FIGS. 14 and 15, the shapes of the first electrical contact area 1331-1332 of the second conductive end 132 and the structural member body 133 are closed loop shapes. The first electrical contact areas 1331-1332 of the structural member body 133 and the second conductive end 132 is arranged on a second end surface 1333 of the structural member body 133 itself. The second end surface 1333 of the present embodiment may be an end surface facing away from the controller. In order to match a position of the first electrical contact areas 1331-1332 of the structural member body 133, the second conductive end 132 is also fixed on the second end surface 1333 of the structural member body 133 when it is in electrical contact with the structural member body 133. When the position of the heater 12 provided in the lens assembly body 11 has an uncertain position based on a different model, then the position of the power supply line 120 is different, any position on the second end surface 1333 of the structural member 13 may be used to electrically connect the power supply line 120 and be fixed. This arrangement of the structural member 13 makes the connection between the heater 12 and the controller 14 more convenient. The first conductive end 131 may be arranged on a first end surface 1336, and electrically connected to the second conductive end 130.

Further, the structural member body 133 may include an outer peripheral surface 1334 and an inner peripheral surface 1335. The installation position of the structural member body 133 on the lens assembly body 11 may be adjusted. For example, the structural member body 133 is arranged on a radial outer side of the optical axis of the lens assembly body 11 and is integrally formed with the lens assembly body 11. In this regard, the structural member body 133 may not have the inner peripheral surface 1335.

As shown in FIGS. 16 and 17, the shape of the first electrical contact area 1331-1332 of the second conductive end 132 and the structural member body 133 is closed loop shape. The first electrical contact areas 1331-1332 of the structural member body 133 and the second conductive end 132 are arranged on the inner peripheral surface 1335 of the structural member body 133 itself. In order to match the position of the first electrical contact areas 1331-1332 of the structural member body 133, the second conductive end 132 is also fixed on the inner peripheral surface 1335 of the structural member body 133 when it is in electrical contact with the structural member body 133. When the position of the heater 12 provided in the lens assembly body 11 has an uncertain position based on a different model, then the position of the power supply line 120 is different, any position on the inner peripheral surface 1335 of the structural member 13 may be used to electrically connect the power supply line 120 and be fixed. The arrangement of the structural member 13 makes the connection between the heater 12 and the controller 14 more convenient. The first conductive end 131 may be arranged on the first end surface 1336, and electrically connected to the second conductive end 132.

As shown in FIGS. 18 and 19, the shape of the first electrical contact area of the second conductive end 132 and the structural member body 133 is closed loop shape. The first positive electrode area 1331 of the structural member body 133 is arranged on the second end surface 1333 of the structural member body 133, and the first negative electrode area 1332 is arranged on the inner peripheral surface 1335 of the structural member body 133. In order to match the position of the first electrical contact area of the structural member body 133, the positive electrode 1321 is also arranged on the second end surface 1333 of the structural member body 133, and fixedly connected to the positive electrode area 1331, when the second conductive end 132 is in electrical contact with the structural member body 133. Similarly, the negative electrode 1322 of the second conductive end 132 may be arranged on the inner peripheral surface 1335 of the structural member body 133, and is fixedly connected to the first negative electrode area 1332. When the position of the heater 12 provided in the lens assembly body 11 has an uncertain position based on a different model, then the position of the power supply line 120 is different, any position on the inner peripheral surface 1335 of the structural member 13 may be used to electrically connect a negative electrode power supply line and be fixed; any position on the second end surface 1333 of the structural member 13 may be used to electrically connect a positive electrode power supply line and be fixed. The arrangement of the structural member 13 makes the connection between the heater 12 and the controller 14 more convenient. The first conductive end 131 may be arranged on the first end surface 1336, and electrically connected to the second conductive end 132.

The positions of the first positive electrode area 1331 and the first negative electrode area 1332 of the structural member body 133 may exchange as required. Correspondingly, the positions of the positive electrode 1321 and the negative electrode 1322 of the second conductive end 132 also exchange, which is not limited herein.

Of course, the form of the first electrical contact areas 1331-1332 of the structural member body 133 is limited by a structural shape of the structural member body 133, so that the number and shape of each electrode of the second conductive end 132 are also limited by the structural shape of the structural member body 133. Illustratively, the shape of the second conductive end 132 includes: a polygonal needle shape, a rectangular sheet shape, or a combination of the polygonal needle shape and the rectangular sheet shape.

Illustratively, the first conductive end 131 is arranged on the first end surface 1336 of the structural member body 133, in particular, fixed to a position corresponding to the output end 141 of the controller 14. The first conductive end 131 may be a pin header, etc., electrically connected to the first electrical contact area through electrical contact and/or concealed wiring. Illustratively, the structural member body 133 includes a conductive portion, and the conductive portion along both ends of the mounting axis may be used as a first electrical connection area and a second electrical connection area.

In an exemplary embodiment, the structural member body 133 is provided with a second electrical contact area, and the second electrical contact area may include a second positive electrode area and a second negative electrode area. The positive electrode 1311 of the first conductive end 131 may be arranged in the second positive electrode area, and the negative electrode of the first conductive end 131 may be arranged in the second negative electrode area.

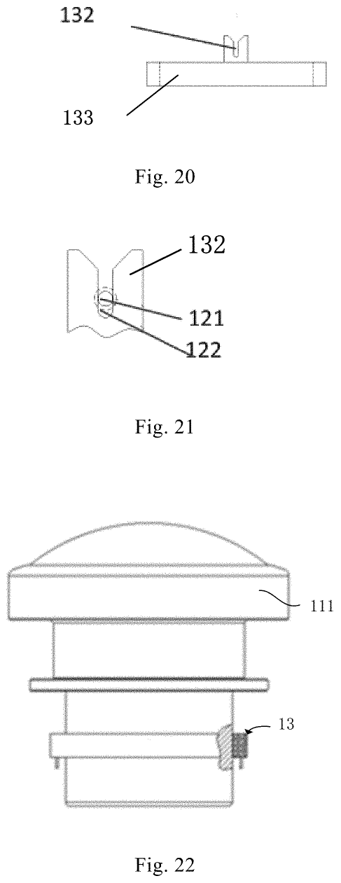

FIG. 20 is a schematic diagram of connection between a second conductive end and a power supply line in a lens assembly module of an exemplary embodiment of the present disclosure; and FIG. 21 is a schematic diagram of connection between a second conductive end and a heater power supply line.

As shown in FIG. 20, the second conductive end 132 is provided with a recess capable of electrical contact with the power supply line 120 of the heater 12. In some embodiments, the second conductive end 132 is provided on the structural member body 133, and is located on a different side from the first conductive end 131. The second conductive end 132 may be connected to the heater through welding interconnection, or piercing connection. As shown in FIG. 21, a diameter of the recess of the second conductive end 132 is slightly smaller than a diameter of the power supply line 120. The power supply line 120 consists of a metal wire 121 and an insulating sheath 122 wrapping the metal wire 121. Since the insulating sheath 122 is soft in texture and easy to be pierced, when the power supply line 120 is connected to the second conductive end 132, the insulating sheath 122 of the power supply line 120 is pierced by the second conductive end 132, so that the metal wire 121 is exposed to the recess of the second conductive end 132, and clamped tightly by the recess. Inevitably, the second conductive end 132 is made of metal. When the second conductive end 132 clamps the metal wire 121 tightly, fixed connection between the structural member 13 and the heater 12 is realized. Further, the structural member 13 and the heater 12 may perform information interaction through electrical signals, avoiding the heater 12 from drawing the power supply line 120 to the outside of the lens assembly body 11 in open wiring, which in turn leads to confusion of the wires of the lens assembly module and affects the assembly efficiency.

In some embodiments, the structural member body 133 is arranged between the first conductive end 131 and the second conductive end 132 in the present disclosure, which is used to integrate an electrical signal transmission line. The electrical signal transmission line is arranged in the form of concealed wiring inside the structural member body 133, avoiding the heater 12 from drawing the power supply line 120 to the outside of the lens assembly body 11 in open wiring, which in turn leads to confusion of the wires of the lens assembly module and affects the assembly efficiency.

In some embodiments, the structural member 13 is fixed to the lens assembly body 11 through the structural member body 133.

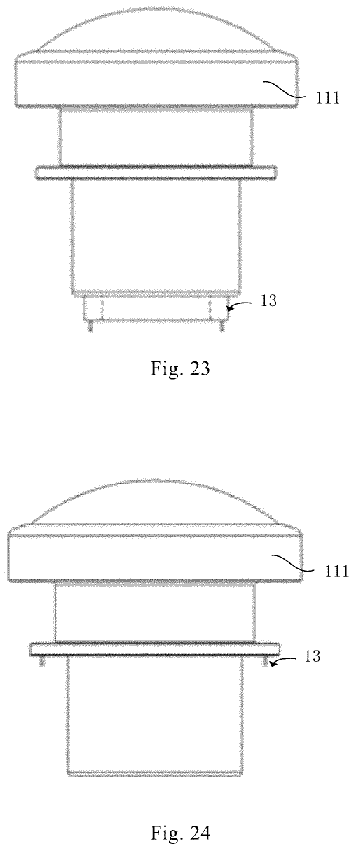

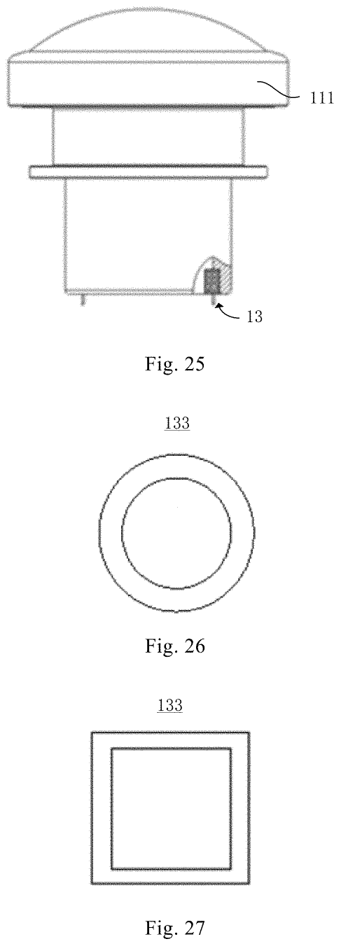

FIGS. 22 to 25 are schematic diagrams of a structural member fixed to different positions of a lens assembly body in a lens assembly module of an exemplary embodiment of the present disclosure. FIG. 22 is a schematic diagram of the structural member body 133 embedded to an outer wall surface of the lens assembly body 11. FIG. 23 is a schematic diagram of the structural member body 133 embedded to a bottom surface of the lens assembly body 11. FIG. 24 is a schematic diagram of the structural member body 133 embedded to a side edge of a protruding part of a protruding portion of the lens assembly body 11. FIG. 25 is a schematic diagram of the structural member body 133 embedded in a bore of the lens assembly body 11. That is, the structural member body 133 may be arranged on the outer wall surface of the lens barrel, the bottom surface of the lens barrel, the side edge of the protruding part of the protruding portion or the bore of the lens assembly body 11. The specific set position may be selected based on its relative position with the controller 14, etc., and a fixed position is not limited, making it convenient for producers to choose according to their needs.

In some embodiments, due to differences in the structure of different lens assembly bodies 11, in order to match the shapes of different lens assembly bodies 11, the shape of the structural member body 133 may also be set in a variety of styles.

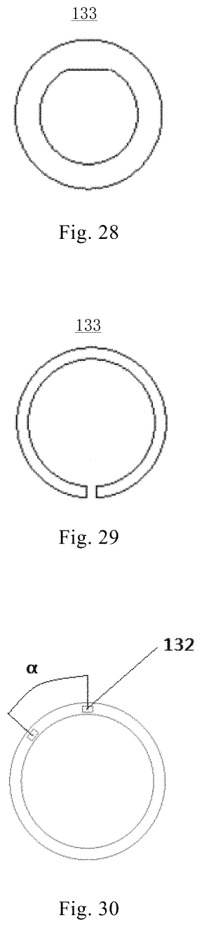

FIGS. 26 to 29 are schematic diagrams of a shape of a structural member body in a lens assembly module of an exemplary embodiment of the present disclosure. FIG. 26 is a schematic structural diagram of the structural member body 133 in a circular shape. FIG. 27 is a schematic structural diagram of the structural member body 133 in a rectangular ring shape. FIG. 28 is a schematic structural diagram of the structural member body 133 being a combination of a circular ring shape and a tangent shape. FIG. 29 is a schematic structural diagram of the structural member body 133 in a broken ring shape. That is, the shape of the structural member body 133 may be set to the circular ring shape, the rectangular ring shape, the combination of the circular ring shape and the tangent shape, or a broken ring shape. Of course, the shape of the structural member body 133 needs to be determined based on the shape of the lens assembly body 11, so that the structural member 13 can be firmly connected to the lens assembly body 11, avoid increasing assembly difficulty due to an unfit shape. In order to ensure that the structural member 13 can match the position of the power supply line 120 of the heater 13 and the position of the output end of the controller 14, the shape of the structural member body 133 must be set in a ring shape, so that the conductive end of the structural member 13 may be fixed at any position in a circumferential direction of the structural member body 133 in the ring shape. Of course, if the lens assembly body 11 is in other shapes, then the specific ring shape of the structural member body 133 may also be set accordingly, which is not limited herein.

In some embodiments, the fixing between the lens assembly 11 and the structural member body 133 may be: hole shaft interference fitting, hot riveting, broken ring snap fixation, snap hook fitting, dispensing fixing and screw locking fixing, etc. As long as the lens assembly body 11 can be fixed firmly to the structural member body 133, producers can assemble according to their own conditions, and the specific fixation is not limited herein.

Further, the two sides of the structural member body 133 are also used to fix the conductive end. Since the lead-out position of the power supply line 120 of the heater 12 is randomly set, the position of the output end of the controller 14 is also set randomly according to its different models, in order to match the lead-out position of the power supply line 120 of the heater 12 and the position of the output end of the controller 14, in the present embodiment, the position of the conductive end of the structural member body 133 may be fixed and installed according to the actual situation.

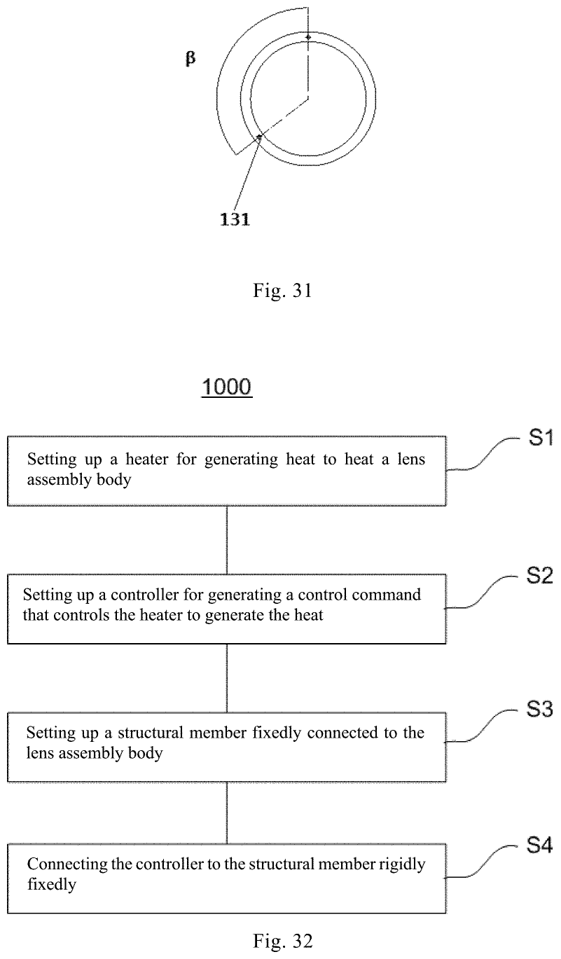

FIG. 30 is a schematic diagram of a position of a second conductive end on a structural member body in a lens assembly module an exemplary embodiment of the present disclosure; and FIG. 31 is a schematic diagram of a position of a first conductive end on a structural member body in a lens assembly module an exemplary embodiment of the present disclosure. As shown in FIG. 30, a first angle α is an inclined angle between the positive electrode and the negative electrode of the second conductive end 132. The first angle α is an inclined angle of the two electrodes in a plane perpendicular to the optical axis relative to the optical axis. In order to match the lead-out position of the power supply line 120 of the heater 12 in different positions, a degree value of the first angle α may be adjusted between 0 degrees and 360 degrees so that connectivity between the structural member 13 and the heater 12 is not constrained by the position of the connection ends.

Similarly, as shown in FIG. 31, a second angle β is an inclined angle between the positive electrode and the negative electrode of the first conductive end 131. In order to match the output end of the controller 14 in different positions, a degree of the second angle β may be adjusted between 0 degrees and 360 degrees so that connectivity between the structural member 13 and the controller 14 is not constrained by the position of the connection ends.

In some embodiments, the structural member body 133 may be selected from materials of less mass such as plastic, such that an overall weight of the lens assembly module is not significantly increased after the inclusion of the structural member 13 in the lens assembly module. The lens assembly module provided in the present embodiment is an optical apparatus, and other types of optical apparatuses including the structural member 13 may also be obtained without departing from the teachings of the present embodiment.

FIG. 32 is a flowchart of a method for manufacturing a lens assembly module of an exemplary embodiment of the present disclosure.

As shown in FIG. 32, based on the above lens assembly module, the present disclosure also provides a method 1000 for manufacturing a lens assembly module, including:

Step S1, setting up a heater for generating heat to heat a lens assembly body.

Step S2, setting up a controller for generating a control command that controls the heater to generate the heat.

Step S3, setting up a structural member fixedly connected to the lens assembly body.

Step S4, connecting the controller to the structural member rigidly fixedly, where the structural member is configured to transmit the control command generated by the controller to the heater.

The method 1000 for manufacturing a lens assembly module is applied to manufacturing of the lens assembly module in the above embodiment, where, specific embodiment of each component of the lens assembly module is described in detail in the above description of the embodiment of the lens assembly module, detailed description thereof will be omitted.

In an embodiment, the structural member includes: a structural member body, a first conductive end, and a second conductive end. The structural member body includes a first electrical contact area and the second conductive end is electrically connected to the first electrical contact area. The step S3 includes:

fixedly connecting the structural member body to the lens assembly body.

electrically connecting the second conductive end to the heater. A position of the second conductive end is determined based on a position of a power supply line of the heater. The second conductive end is then fixedly connected to the power supply line, and thus the second conductive end is electrically connected to the heater.

fixing the second conductive end at a position in the first electrical contact area corresponding to the heater.

fixing the first conductive end at a position in a second electrical contact area corresponding to an output end of the controller, where the second conductive end is electrically connected to the first conductive end through the structural member body;

rigidly electrically connecting the first conductive end to the output end of the controller, to receive the control command from the controller.

Illustratively, when fixing the structural member body, the structural member body may be fixed in response to a fixed connection position of the lens assembly body and the heater, so that the second conductive end corresponds to the position of the power supply line.

Illustratively, when fixing the first conductive end, the first conductive end may be fixed in the aforementioned position in response to a fixed connection position of the lens assembly body and the controller.

Further, based on styles of the structural member body, the first conductive end and the second conductive end, the structural member body may be connected to the lens assembly body, and the second conductive end may be connected to the heater through corresponding different methods.

The method 1000 for manufacturing a lens assembly module of the present disclosure, accurately positions the first conductive end of the structural member based on the position of the output end of the controller, and accurately positions the second conductive end of the structural member based on the position of the power supply line of the heater, then connects the heater and the controller through the structural member, thus avoiding the situation in the prior art where assembly of the heater and the controller is impossible due to mismatch between the lead-out position of the power supply line of the heater and the position of the output end of the controller, thereby reducing the difficulty of assembling the heating lens assembly and the controller, and improving the assembly efficiency and production capacity of the heating lens assembly and the controller.

In addition, the heater is connected to the controller by providing the structural member having a rigid conductive end, which reduces the difficulty of assembling the heater and the controller, and at the same time avoids uncontrollability of the power supply line of the heater, and guarantees stability of the heater and the controller after the assembly.

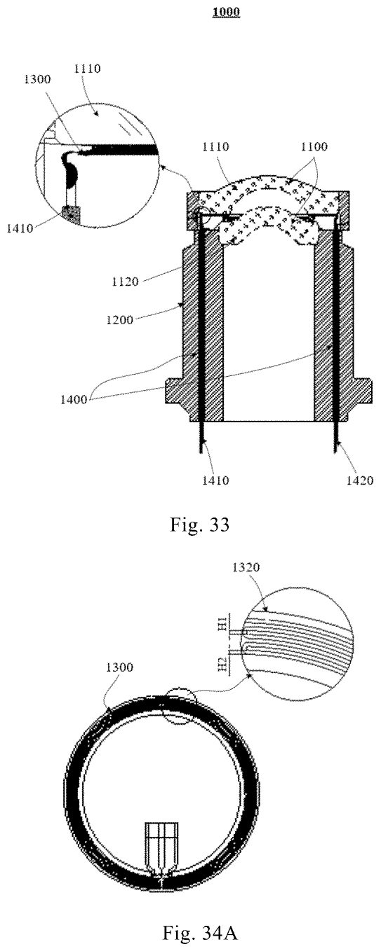

Referring to FIG. 33, illustrating a schematic diagram of the lens assembly 1000 according to another embodiment of the present disclosure.

The lens assembly 1000 may include a lens component 1100, a lens barrel 1200, a heating unit 1300, and a connection component 1400. The connection component 1400 may be a conductive unit.

The lens component 1100 may include at least one lens for adjusting and spreading light, thereby facilitating an imaging or projection action of the lens assembly. For example, the lens component 1100 may include a first lens 1110 and a second lens 1120 arranged opposite each other, where the first lens 1110 and the second lens 1120 may be bonded together by a bonding material. Light may incident along the first lens 1110 to the second lens 1120, or may incident along the second lens 1120 to the first lens 1110.

The lens barrel 1200 may be connected to a non-optical area of the lens component 1100 to fix the lens component 1100. For example, the lens barrel 1200 may be connected to the non-optical area of the first lens 1110 and the second lens 1120 to fix the first lens 1110 and the second lens 1120.

The heating module 1300 may be arranged in the non-optical area of the lens component 1100. The heating module 1300 may be arranged in the non-optical area of a lens closest to the external environment in the lens component 1100. For example, in the lens assembly 1000 shown in FIG. 33, the heating module 1300 may be arranged in a non-optical area of the first lens 1110 that is close to the external environment. Arranging the heating module 1300 in the non-optical area of the lens component 1100 facilitates a defogging and defrosting effect on the lens assembly without affecting light spreading. In addition, by arranging the heating module 1300 in the non-optical area of the lens component 1100, it may effectively avoid problems such as oversized overall structure of the lens assembly 1000 and restricted installation space.

The connection component 1400 may be connected to the heating module 1300 through the lens barrel 1200, where the connection component 1400 is adapted to be connected to an external power source so as to supply power to the heating module 1300. For example, the connection component 1400 may pass through the lens barrel 1200 and then be connected to the heating module 1300 by welding. The connection component 1400 may include a first connection component 1410 and a second connection component 1420, where the first connection component 1410 and the second connection component 1420 may pass through both sides of the lens barrel 1200 and then be connected to the heating module 1300, where the first connection component 1410 and the second connection component 1420 are connected to the external power source so as to supply power to the heating module 1300, to allow the heating module 1300 to generate heat to remove fog or ice crystals generated on the surface of the lens assembly. Illustratively, the first connection component 1410 and the second connection component 1420 may be wires having protective sleeves.

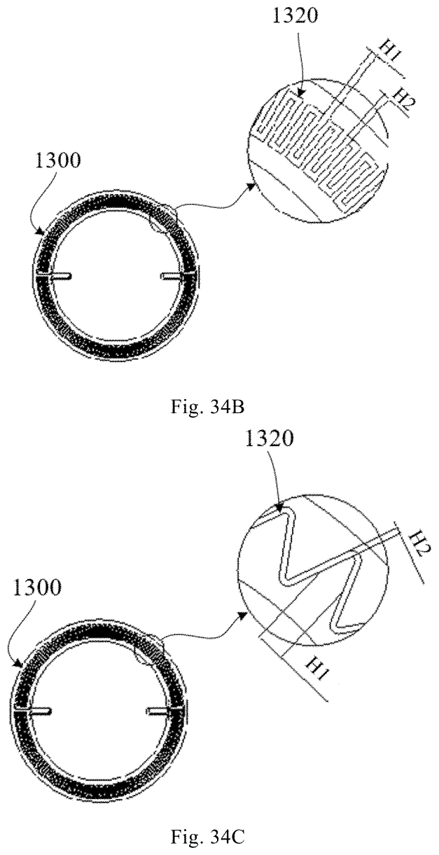

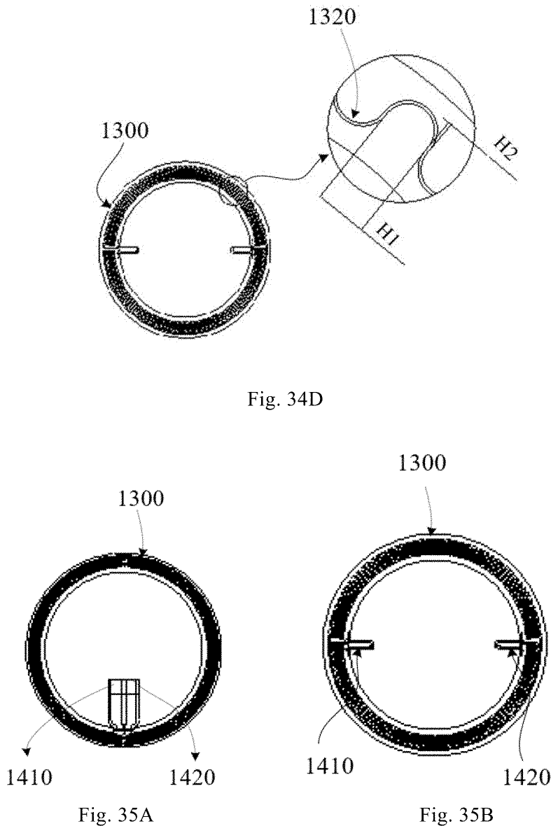

In an exemplary embodiment, the heating module 1300 may include the first film layer 1310, the heating layer 1320, and the second film layer 1330, arranged in sequence. Illustratively, the first film layer 1310 and the second film layer 1330 may be made of polyimide (PI) material. Illustratively, the first film layer 1310 and the second film layer 1330 may be PI films made of polyimide (PI) material. The heating layer 1320 may serve as the aforementioned heat generating element. For example, the heating layer 1320 may be made of at least one metal foil material, such as rolled copper foil (RA copper foil), electrolytic copper foil, Constantan copper foil (copper-nickel alloy), and/or stainless steel. For example, the heating layer 1320 may be a wire-shaped heating wire made of at least one metal foil material, such as rolled copper foil, electrolytic copper foil, Constantan copper foil, and/or stainless steel. The heating layer 1320 may be a heating wire formed, in the non-optical area of the first lens 1110, by at least one wire shape of a circular shape, a bow shape, a zigzag shape, and a circular ring shape. It should be understood that the present disclosure does not limit the set shape of the heating layer, and any shape that meets the requirements may be designed according to the actual situation. the spacing H1 and the width H2 of the wire-shaped heating wire each may be greater than or equal to 0.02 mm. In the present disclosure, the metal foil may be etched to form the wire-shaped heating wire by an etching process. As shown in FIG. 34A, the metal foil may be etched to form a circular heating wire circuit. As shown in FIG. 35B, the metal foil may be etched to form a bow-shaped heating wire circuit. As shown in FIG. 35C, the metal foil may be etched to form a zigzag-shaped heating wire circuit. As shown in FIG. 35D, the metal foil may be etched to form a circular ring-shaped heating wire circuit. It should be understood that the heating module 1300 provided in the present disclosure may be set by reasonably setting the shape of the heating layer 1320, to meet a resistance requirement for the heating layer 1320 in practical applications, and thus heating uniformity of the heating module 1300 may be ensured. The resistance of the heating layer 1320 is R=ρL/S, p is resistivity of the heating layer, L is a length of the heating wire, and S is a cross-sectional area of the heating wire, i.e., S=width W*thickness T. When actually designing the circuit of the heating layer, it is necessary to consider the resistivity ρ, the thickness T, the width W, and the length L of the heating wire of the metal foil material made into the heating layer, and then control a size of the resistance R and a shape of a pattern into which the heating wire is set. According to the formula P=U²/R, when voltage provided by the external power supply is certain, a heating power of the heating layer may be controlled by controlling the resistance R.

The first film layer 1310 and the second film layer in the heating module 1300 may be PI films. The heating layer 1320 may be formed by performing an etching process on the metal foil to form the heating wire. The first connection component 1410 and the second connection component 1420 may be wires having protective sleeves. The first connection component 1410 and the second connection component 1420 may pass through the lens barrel 1200 and then be connected to the heating module 1300 by welding. The electrodes of the first connection component 1410 and the second connection component 1420 may be obtained by etching a lead out end of the heating wire, and positions of the electrodes are partially uncovered with PI films, to form an electrode that can be externally connected. It should be understood that the present disclosure does not limit the electrodes and the lead-out method the wires, according to the actual situation, it is possible to design any electrode and wire lead-out method to meet the requirements. Due to excellent solderability of chemical gold, in the present disclosure, chemical gold processing may be performed on surfaces of the electrodes, that is, through chemical method, a layer of thick nickel-gold alloy having good electrical properties may be wrapped around the copper surface. The nickel-gold alloy may be quickly merged into the melted solder, and the solder forms a Ni/Sn metal compound with Ni, for welding the connection component 1400 and the heating module 1300.

In an exemplary embodiment, as shown in FIG. 35A and FIG. 35B, the first connection component 1410 and the second connection component 1420 provided in the present disclosure may be respectively connected, in a 0°-180° range, to the positions on the non-optical area of the heating module 1300, away from the first lens, i.e., positions of the heating module 1300 that is close to an optical area of the first lens. In other words, the first connection component 1410 and the second connection component 1420 may be connected to an inner side of ring in the non-optical area where the heating module 1300 is provided, respectively. FIG. 35A and FIG. 35B only exemplarily illustrate the first connection component 1410 and the second connection component 1420 connected to the inner side of ring in the non-optical area where the heating module 1300 is provided at intervals of 0° and 180°, respectively. It should be understood that the positions of the first connection component 1410 and the second connection component 1420 may be adjusted in the range of 0°-180° depending on the arrangement of the heating wire.

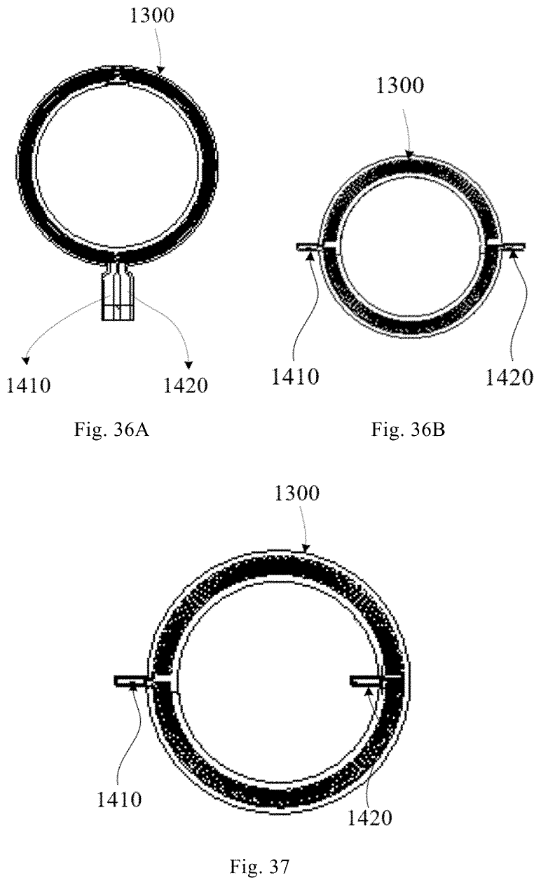

In an exemplary embodiment, as shown in FIG. 36A and FIG. 36B, the first connection component 1410 and the second connection component 1420 provided in the present disclosure may be respectively connected, in a 0°-180° range, to positions of the heating module 1300 close to the non-optical area of the first lens, i.e., the positions of the heating module 1300 that is away from the optical area of the first lens. In other words, the first connection component 1410 and the second connection component 1420 may be connected to an outer side of the ring in the non-optical area where the heating module 1300 is provided, respectively. FIG. 36A and FIG. 36B only exemplarily illustrate the first connection component 1410 and the second connection component 1420 connected to the outer side of ring in the non-optical area where the heating module 1300 is provided at intervals of 0° and 180°, respectively. It should be understood that the positions of the first connection component 1410 and the second connection component 1420 may be adjusted in the range 1 of 0°-180° depending on the arrangement of the heating wire.

In an exemplary embodiment, as shown in FIG. 37, the first connection component 1410 and the second connection component 1420 provided in the present disclosure may be connected, in a 0°-180° range, to an end close to the non-optical area of the first lens and an end away from the non-optical area of the first lens, of the heating module 1300, respectively. In other words, the first connection component 1410 and the second connection component 1420 may be respectively connected to the outer side and the inner side of the ring in the non-optical area where the heating module 1300 is provided. FIG. 37 only exemplarily illustrates the first connection component 1410 and the second connection component 1420 connected to the outer side and the inner side of ring in the non-optical area where the heating module 1300 is provided at intervals of 0° and 180°, respectively. It should be understood that the positions of the first connection component 1410 and the second connection component 1420 may be adjusted in the range of 0°-180° depending on the arrangement of the heating wire.

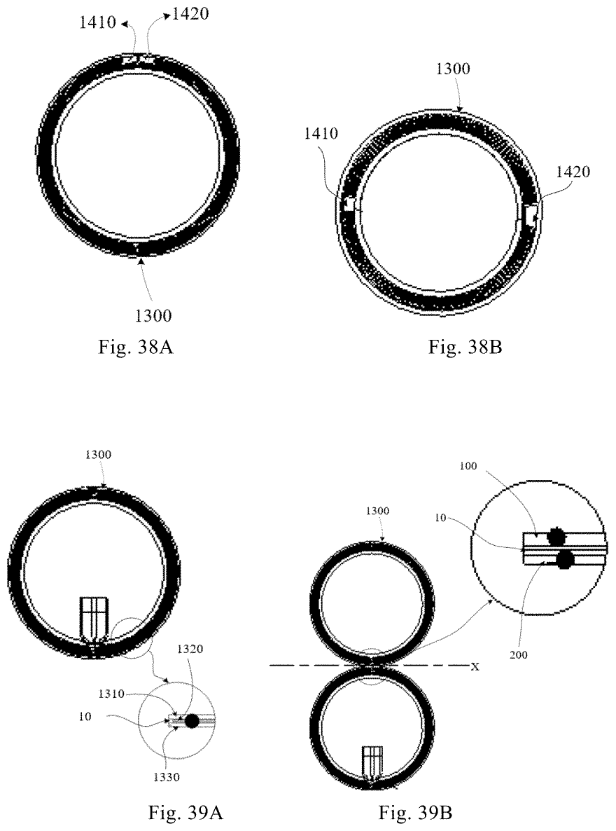

In an exemplary embodiment, as shown in FIG. 38A and FIG. 38B, the first connection component 1410 and the second connection component 1420 provided in the present disclosure may be connected, in a 0°-180° range, to the inside of the heating module 1300, respectively. FIG. 38A and FIG. 38B only exemplarily illustrate the first connection component 1410 and the second connection component 1420 connected to the inside of the heating module 1300 at intervals of 0° and 180°, respectively. It should be understood that the positions of the first connection component 1410 and the second connection component 1420 may be adjusted in the range of 0°-180° depending on the arrangement of the heating wire.

It should be understood that, in practical applications, the position where the first connection component and the second connection component lead out in the heating layer depends on the design of a graphic arrangement of the heating wire inside the heating layer. The positions of the first connection component and the second connection component lead out in the heating layer may be arranged either at the end of the heating layer, i.e., the outer end of the heating layer close to the non-optical area of the lens or the inner end of the heating layer away from the non-optical area of the lens, or may be arranged inside of the heating layer. Illustratively, the first connection component and the second connection component may be used as two leads of the conductive unit, further, as a positive power supply line and a negative power supply line, respectively.

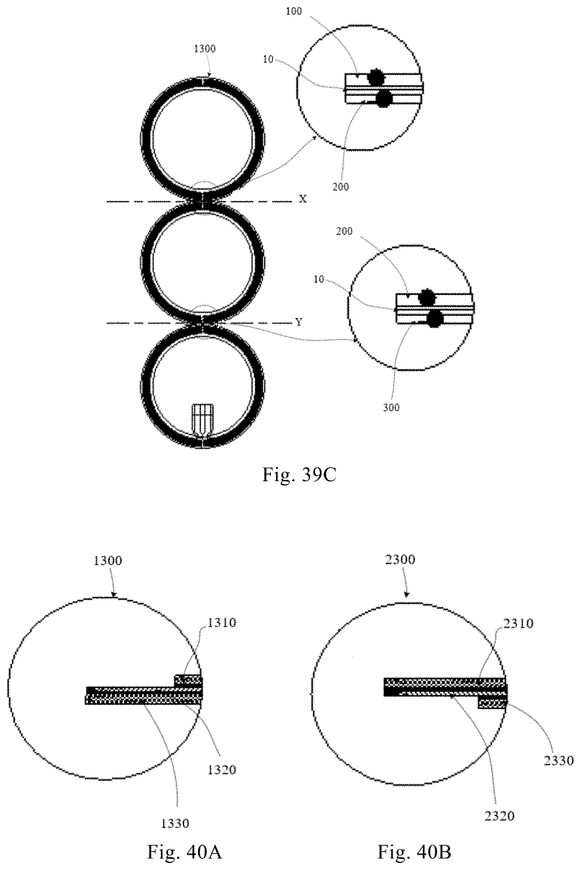

In an exemplary embodiment, as shown in FIGS. 39A to 39C, the heating module 1300 provided in the present disclosure may be folded and arranged in the non-optical area of the lens. The first film layer 1310 and the second film layer 1330 may be films made of PI material, which may be arbitrarily folded to form a multi-layer heating module. By connecting the multi-layer heating wire in series, the resistance of the heating layer 1320 may be increased. In addition, the multi-layer folded heating module may be connected to each other by means of glue, tape, etc. As shown in FIG. 39A, the heating module 1300 includes a PI film, a heating wire, and a PI film, arranged in sequence, where the PI film, the heating wire, and the PI film are bonded together using a glue 10, etc. As shown in FIG. 39B, the heating module 1300 is formed by folding a first heating module 100 and a second heating module 200 opposite each other along an X axis, where the heating wire of the first heating module 100 and the heating wire of the second heating module 200 are connected in series. The first heating module 100 and the second heating module 200 are bonded together using the glue 10 or other adhesives. As shown in FIG. 39C, the heating module 1300 is formed by folding the first heating module 100, the second heating module 200, and a third heating module 300 together in sequence along the X axis and a Y axis, where the heating wire of the first heating module 100, the heating wire of the second heating module 200, and the heating wire of the third heating module 300 are connected in series. The first heating module 100 and the second heating module 200 are bonded together using glue or other adhesives, and the second heating module 200 and the third heating module 300 are bonded together using glue or other adhesives. It should be noted that in the present disclosure, when bending the multi-layer heating wire, the position(s) where the bending occurs is contiguous so that the multi-layer heating wires are conductive. It should be understood that the heating module provided in the present disclosure is not limited to a heating module with less than three layers, the above presentation is only an example, is not intended to strictly limit the number of layers of the heating module, in practical applications, the number of layers of the heating module may be set reasonably according to the specific condition. For example, in practical applications, there are often situations where an arrangement width (area) for the heating module is limited, and actual requirements cannot be achieved by controlling the resistance of the heating wire only, in this regard, the resistance requirement may be achieved by stacking several times to increase the area where the heating wire can be arranged.

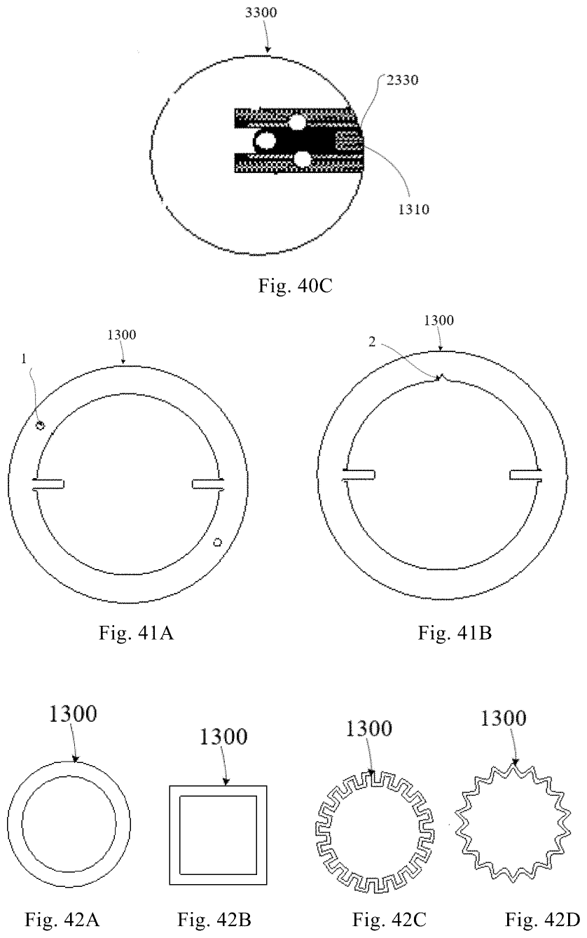

In an exemplary embodiment, as shown in FIGS. 40A to 40C, the heating module 1300 provided in the present disclosure may be stacked and arranged in the non-optical area of the lens. As shown in FIG. 40A, the heating module 1300 includes the first film layer 1310, the heating layer 1320, and the second film layer 1330, arranged in sequence, where the first film layer 1310 does not completely cover the heating layer 1320. As shown in FIG. 40B, a heating module 2300 includes a first film layer 2310, a heating layer 2320, and a second film layer 2330, arranged in sequence, where the second film layer 2330 does not completely cover the heating layer 2320. As shown in FIG. 40C, the heating module 1300 and the heating module 2300 are stacked to form a heating module 3300. The first film layer 1310 and the second film layer 2330 may be bonded together by glue. In this regard, the electrodes of the heating layer 1320 and the heating layer 2320 may be electrically connected in series by, e.g., electric conductive adhesive and electric conductive tape, thus achieving the effect of stacking multiple heating layers. The first film layer 2310 and the second film layer 2330 provided in the present disclosure may be films made of PI material, which may be arbitrarily stacked to form multiple layers of heating modules. The multiple layers of stacked heating modules may be connected to each other by means of glue, tape, etc. The electrodes of the multi-layer heating module may be electrically connected by, e.g., electric conductive adhesive and electric conductive tape.

In an exemplary embodiment, the heating module 1300 may have thereon an aperture marking, and a notch marking, or an aperture marking and a notch marking. In actual production of the heating module, multiple heating modules are usually integrated on one sheet of material and subsequently cut out through processes such as stamping, laser cutting, which tends to confuse the multiple heating modules. The heating module provided in the present disclosure can identify a heating module in demand by designing a different marking on the heating module. As shown in FIG. 41A, one or more round hole markings 1 may be designed on the heating module 1300. It should be understood that the presentation of the shape and number of markings in the present disclosure is only an example and not strictly limited, and the shape and number of markings may be any shape and number that meet the actual requirements, for example, the marking may also be irregular holes such as triangular holes, flower holes. As shown in FIG. 41B, one or more triangular notch markings 2 may be designed on the heating module 1300, where the notch may also be semicircular, rectangular, and in other irregular shapes. The number of notches may be one or more. The notch may be on the inside of the heating module or on the outside of the heating module. Illustratively, identification marking on the heating module may be used both as positioning fit for assembly and as identification marking on automated vision for identification detection.

In an exemplary embodiment, as shown in FIG. 42A, a contour of the heating module 1300 may be circular in shape. As shown in FIG. 42B, the contour of the heating module 1300 may be square. As shown in FIG. 42C, the contour of the heating module 1300 may be bow-shaped. As shown in FIG. 42D, the contour of the heating module 1300 may be serpentine (S) shaped. It should be understood that the presentation of the contour of the heating module 1300 in the present disclosure is only an example and is not strictly limited, and the contour of the heating module 1300 may be any shape that meets actual requirements.

In an exemplary embodiment, the heating module 1300 includes a first reinforcing plate 1311 arranged on a surface of the first film layer 1310. Illustratively, the heating module 1300 may also include a second reinforcing plate 1331 arranged on a surface of the second film layer 1330. The first reinforcing plate 1311 and the second reinforcing plate 1331 may be made of at least one of aluminum, stainless steel, copper, FR4, asbestos, vacuum plate, and/or aerogel felt. The first reinforcing plate 1311 may be arranged on the surface of the first film layer 1310 based on a shape of the first film layer 1310, and the second reinforcing plate 1331 may be arranged on the surface of the second film layer 1330 based on a shape of the second film layer 1330. The first reinforcing plate 1311 and the second reinforcing plate 1331 may be used to locally strengthen or overall strengthen stress of the heating module 1300 to cope with some processes that require force, such as riveting, or printing. The first reinforcing plate 1311 and the second reinforcing plate 1331 provided in the present disclosure may be made of materials with good thermal conductivity, such as aluminum, stainless steel, or copper, and may also be made of materials with good thermal insulation, such as FR4, asbestos, vacuum plate, or aerogel felt.

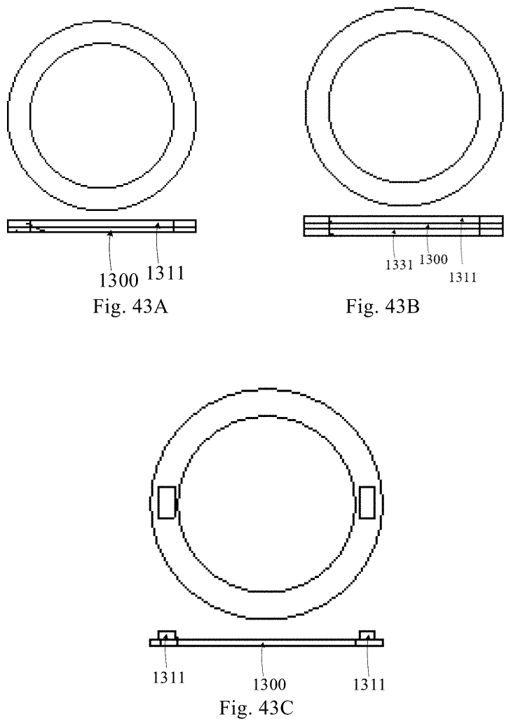

As shown in FIG. 43A, the first reinforcing plate 1311 is arranged on the surface of the first film layer 1310 to completely cover the surface of the first film layer 1310. The first reinforcing plate 1311 may be a material with good thermal conductivity to make the heating module 1300 generate heat uniformly. As shown in FIG. 43B, the first reinforcing plate 1311 and the second reinforcing plate 1331 are arranged on the surfaces of the first film layer 1310 and the second film layer 1330 to completely cover the surfaces of the first film layer 1310 and the second film layer 1330. In other words, the heating module 1300 is provided with the first reinforcing plate 1311 and the second reinforcing plate 1331 on two surfaces in contact with the outside. The first reinforcing plate 1311 may be a material with good thermal conductivity to make the heating module 1300 generate heat uniformly. The second reinforcing plate 1331 may be a material with good thermal insulation to reduce heat dissipation of the heating module 1300, reduce losses, and improve thermal utilization. As shown in FIG. 43C, the first reinforcing plate 1311 is provided in a local area on the surface of the first film layer 1310. The first reinforcing plate 1311 may be a material with good thermal conductivity or a material with good thermal insulation, which may create a local heat transfer or local thermal insulation effect.

According to another aspect of the present disclosure, an optical apparatus (not shown) is provided, and the optical apparatus includes the lens assembly having a heating function as described above. The optical apparatus may be installed in a limited space because the lens assembly having a heating function enables normal use in a cold and humid external environment.

The above description is only an explanation of the implementation mode of the application and the applied technical principles. Those skilled in the art should understand that the scope of protection involved in this application is not limited to the technical solution formed by the specific combination of the above technical features, but also covers other technical solutions formed by the arbitrary combination of the above technical features or their equivalent features without departing from the technical concept. For example, the above features and the technical features disclosed in the application (but not limited to) with similar functions are replaced each other to form a technical solution.

What is claimed is:

1. A heating apparatus for a lens, the lens comprising a lens body, the lens body having a first surface and a second surface opposite to each other, and an edge connecting the first surface and the second surface, the heating apparatus comprising:
a heating unit, adapted to be arranged on the edge of the lens body and configured to transfer heat to the lens body after being powered.

2. The heating apparatus according to claim 1, wherein the heating unit comprises a ceramic heating ring provided with a heat generating element or a polyimide heating film provided with the heat generating element.

3. The heating apparatus according to claim 1, wherein the heating apparatus further comprises a fixing element, the fixing element being configured to fix the heating unit to the edge of the lens body,
wherein the fixing element is a thermal conductive glue, a thermal conductive tape, an electric conductive glue, an electric conductive tape, or a resilient component;
wherein when the fixing element is the resilient component, the heating unit is fixed to the edge by resilience of the resilient element.

4. The heating apparatus according to claim 2, wherein the heat generating element is arranged between two layers of the polyimide film, and the heat generating element is connected to each polyimide film through at least one of a thermal conductive glue, to thermal conductive tape, an electric conductive glue, or an electric conductive tape.

5. The heating apparatus according to claim 2, wherein the polyimide heating film is a rigid carrier polyimide heating film.

6. The heating apparatus according to claim 1, wherein the heating apparatus further comprises an electric conductive unit electrically connected to the heating unit, and the electric conductive unit comprises at least two leads,
wherein the heating apparatus further comprises: an energy supply unit; and the electric conductive unit is configured to provide electrical connection between the heat generating element and the energy supply unit.

7. The heating apparatus according to claim 6, wherein the electric conductive unit is connected to the heat generating element through one or more of welding, an electric conductive glue, an electric conductive tape, a thermal conductive glue, a thermal conductive tape, and compacting connection.

8. The heating apparatus according to claim 6, further comprising a structural member, and the structural member comprising:
a structural member body, configured to fixedly connect to the lens;
a first terminal, fixedly connected to the structural member body, configured to be rigidly fixedly connected and electrically connected to an external power supply; and
a second terminal, electrically connected to the first terminal through the structural member body, and configured to electrically connect to the heating unit through the at least two leads.

9. The heating apparatus according to claim 8, wherein the structural member body comprises a first electrical contact area;
the first terminal is a first conductive end, electrically connected to the first electrical contact area and rigidly electrically connected to an output end of the external power supply; and
the second terminal is a second conductive end, fixed in the first electrical contact area at a position corresponding to the at least two leads.

10. The heating apparatus according to claim 9, wherein the first conductive end is configured to position when the structural member is connected to the external power supply.

11. The heating apparatus according to claim 9, wherein the first conductive end and the second conductive end each comprises a positive electrode and a negative electrode, and the first electrical contact area comprises a first positive electrode area and a first negative electrode area;
the positive electrode of the first conductive end is electrically connected to the first positive electrode area, and the positive electrode of the second conductive end is arranged at a position in the first positive electrode area corresponding to a positive power supply line of the at least two leads; and
the negative electrode of the first conductive end is electrically connected to the first negative electrode area, and the negative electrode of the second conductive end is arranged at a position in the first negative electrode area corresponding to a negative power supply line of the at least two leads.

12. The heating apparatus according to claim 11, wherein the structural member body has a mounting axis, and the structural member body is adapted to be fixedly connected to the lens by coinciding the mounting axis with an optical axis of the lens;
the structural member body comprises at least one of: a first end surface and a second end surface opposite each other in a direction of the mounting axis, an inner peripheral surface surrounding the mounting axis, or an outer peripheral surface surrounding the mounting axis, wherein the second end surface faces towards the at least two leads;
the first positive electrode area is located on the second end surface, the inner peripheral surface, or the outer peripheral surface; and
the first negative electrode area is located on the second end surface, the inner peripheral surface, or the outer peripheral surface.

13. The heating apparatus according to claim 8, wherein a shape of the first terminal comprises: a polygonal needle shape, a rectangular sheet shape, or a combination of the polygonal needle shape and the rectangular sheet shape.

14. The heating apparatus according to claim 8, wherein the second terminal is a second conductive end, connected to the at least two leads through welding interconnection or piercing connection.

15. The heating apparatus according to claim 1, wherein,
the heating unit comprises a first film layer, a heat generating element, and a second film layer that are arranged in sequence;
the first film layer and the second film layer are made of polyimide material; and
the heat generating element is made of at least one metal foil material in the rolled copper foil, electrolytic copper foil, Constantan copper foil, and stainless steel.

16. The heating apparatus according to claim 1, wherein
the heating unit comprises a first film layer, a heat generating element, and a second film layer that are arranged in sequence; and
the heat generating element is arranged in a shape of wire on the edge, wherein a spacing and a width of the wire are greater than or equal to 0.02 mm.

17. The heating apparatus according to claim 1, wherein
the heating unit comprises a first film layer, a heat generating element, and a second film layer that are arranged in sequence; and
the heating unit is folded and arranged on the edge, wherein the folded heat generating elements is connected in series.

18. The heating apparatus according to claim 1, wherein
the heating unit comprises a first film layer, a heat generating element, and a second film layer that are arranged in sequence;
the heating apparatus further comprises a conductive unit electrically connected to the heating unit; and
wherein the heating unit is stacked and arranged on the edge, wherein the stacked conductive unit are electrically connected with each other.

19. A lens having a heating apparatus, comprising a lens body, the lens body having a first surface and a second surface opposite to each other, and an edge connecting the first surface and the second surface, wherein the lens further comprises:
a heating apparatus, arranged on the edge of the lens body, configured to transfer heat to the lens body when powered,
wherein the heating apparatus is configured as a ceramic heating ring with a heat generating element provided inside or a polyimide heating film with the heat generating element provided inside.

20. The lens according to claim 19, wherein the lens is provided with a notch groove, and the heating apparatus is arranged in the notch groove.

21. The lens according to claim 19, wherein the heating apparatus further comprises a fixing element, configured to fix the heating apparatus to the edge.

22. The lens according to claim 19, wherein a mechanism member is provided between lenses, and the ceramic heating ring is formed as the mechanism member.
